(19) United States
(12) Patent Application Publication
(10) Pub. No.: US 2006/0122845 A1
(43) Pub. Date: Jun. 8, 2006

(54) Method and apparatus for the analysis of complex systems

(76) Inventors: Mark Denford, New South Wales (AU); John Leaney, New South Wales (AU); Tim O'Neill, New South Wales (AU); David Rowe, London (GB)

Correspondence Address: SEYFARTH SHAW LLP, 55 E. MONROE STREET, SUITE 4200, CHICAGO, IL, 60603-5803, US

(21) Appl. No.: 10/523,582

(22) PCT Filed: Jul. 31, 2003
(86) PCT No.: PCT/AU03/00979

§ 371 Date: Nov. 15, 2005

(30) Foreign Application Priority Data
Jul. 31, 2002 (AU) 2002950509
Nov. 5, 2002 (AU) 2002953623

(51) Int. Cl. G06Q 99/00

(52) U.S. Cl. 705/1

(57) ABSTRACT

The present invention relates to a method and apparatus for the analysis, particularly, of computing systems. The invention implements an architecture based analysis. The architecture of the system to be analysed is first of all modelled, using a hierarchical model comprising Connections, Components, and other entities. The modelling requires the steps of obtaining the architecture of the system and populating a database or file with the architecture model. The modelled architecture is then evaluated, probably by running simulations of operation of the architecture and also by visualising the architecture using a number of different visualisations. Following the evaluation, changes may be imposed to the architectural model and to the system in order to meet non-functional requirements.

### FIELD OF THE INVENTION

The present invention relates to a method and apparatus for the analysis of systems, particularly, but not exclusively, complex systems, and particularly, but not exclusively, to a method and apparatus for analysis of computing systems.

### BACKGROUND OF THE INVENTION

There are many known types of computing systems, of varying levels of complexity and utilising various types of software and hardware platforms. Such systems play critical roles in organisations and indeed in society. We are now becoming increasingly reliant on them.

Any computing system can be considered in terms of functional requirements and non-functional requirements. The functional requirements are those which it is stated that the system can achieve in day to day operation. For example, a billing system must have the requisite algorithms and business processes to achieve the billing requirements of an organisation (which might be quite complex, for example in the case of a telecomms organisation which has a number of different billing approaches to its clients). The non-functional requirements are requirements that are generally considered to be outside the ambit of the fundamental functional purpose of the system. An example is system “evolvability”. For example, if an organisation is predicted to grow by a certain amount in a certain time period, will their computing system(s) be able to handle the growth and still meet the organisations requirements? For example, in the case of a billing system, growth of the organisation into different client areas may require different types of billing processes to be carried out by the system. Can the system conveniently be “evolved” to incorporate the new billing processes? Even more fundamentally, with a large growth in client base, can the system be evolved to handle the increased number of transactions that may need to take place?

Other non-functional requirements (and the following are only examples and the present document is not limited to these examples) include performance (is the system able to achieve the required performance—speed, output etc); openness (is the system easily interfaced with other systems that may be required by the organisation, or the organisation may be required to interface with), and many others.

The approaches that organisations take towards complex systems (either developing complex systems, maintaining complex systems or acquiring complex systems) in respect of non-functional requirements are generally adhoc and unsatisfactory. For example, an organisation may become aware that their complex and expensive billing system is not operating optimally or providing optimal results, perhaps because they or their client base have grown and the system is no longer able to cater satisfactorily. Some development of the system is therefore required. Presently, such an organisation would usually approach a software supplier (of the billing system) who may offer an upgraded system which takes little account of long term non-functional requirements and which may not (without significant amendment) satisfy the present requirements of the organisation. The organisation is nevertheless “locked in”, in many cases to that software supplier and has no real choice or manner of assessing the upgrade so must take the upgrade. They are then faced with making amendments to the upgrade and their system. Even more drastically, the software provider may no longer be supporting their system and may recommend a totally new billing system, at great expense, time and trouble. The upgrades and amendments provided by the supplier often don't really take into account a particular organisation's non-functional requirements in any rigorous way.

Importantly, the organisation has no way of assessing whether the upgrades or new software provided by the supplier satisfy the non-functional requirements of the organisation. There is no tool presently available which can be used to provide assessment of whether or not a complex system meets non-functional requirements.

Similar problems face system developers. The approach taken to development, although generally logical and structural, does not take a satisfactory approach to fulfilling non-functional requirements. There is generally no rigorous consideration of non-functional requirements affect on development of systems, the priority being in ensuring the system satisfies the functional requirements.

There is a need for a new and logical approach to the analysis of complex systems which may facilitate development, maintenance and acquisition of complex systems.

### SUMMARY OF THE INVENTION

In a first aspect, the present invention provides an apparatus for analysing systems, the apparatus comprising an architecture storing means for storing architecture information about the architecture of the system, and evaluation means for evaluating the architecture in terms of non-functional requirements of the system, utilising the architecture information.

Preferably, the system to be analysed is a “complex” system. Real-world systems are almost always made up of a large number of components that interact in varying and complex ways. This leads to complex behaviour which is difficult to understand, predict and to manage. Research into the characterisation and control of such systems attempts to describe them in explicit (often mathematical) ways, in order to provide enhanced degrees of understanding, predicability, control and efficiency in management. Very simple control systems include the thermostat that controls the temperature of a hot water system, or a street light that comes on at dusk. Much more complex systems which benefit from the application of research into control system characterisation include the Internet, air traffic control, irrigation, robotics and a wide array of systems associated with power and distribution, telecommunications, defence, manufacturing transport and finance, as well as ecological and biological systems, and others. The present invention preferably relates to the analysis of complex systems, and preferably to the analysis of computing systems (but is not limited thereto).

Every complex system has an “architecture”. The architecture will have a particular structure, behaviour and qualities in each case. For example, there will be various technologies under pinning the architecture and various “styles” (eg. the architecture in a computing system may include a client/server approach). Preferably, in the present invention, the architecture is defined in terms of “components” and “connections” between components. Information on the components and connections between the components is preferably stored by the apparatus. Preferably, the architecture information is also defined as including “constraints”, being the constraints which the architecture is limited to. Constraints may include component/connection types, cardinality, performance, etc.

The constraints may be determined in part by financial limitations of an organisation.

Preferably, the entire architecture can be modelled using the “components” and “connections” model. The model also includes “Ports” which act to connect the components and the connections. There are preferably two types of ports that components can have: “client/sender” or “server/receiver” depending on the type of connection (client/server or event etc). Components preferably accept messages from connections and client/sender and forward them onto the next component en route to their destination connection server/receiver. Each component along the route packs, unpacks or passes through the message, adding or removing bytes to the package along the way.

The model preferably further includes “Devices” which provide processing capacity to components and connections. The Devices are preferably contained within components.

Preferably, there are two types of connections; unidirectional (type 0—event etc) or bidirectional (type 1—client/server etc).

Advantageously, utilising the simple component/connection model, complex architectures can conveniently be represented and evaluated.

The approach taken by the apparatus of the present invention is to analyse the complex system by evaluating its architecture, by utilising the architecture information, in relation to its ability or potential to satisfy non-functional requirements of the complex system. An organisation, for example, may have particular non-functional requirements, such as evolvability, openness, etc. The apparatus of the present invention preferably includes means for quantifying the non-functional requirements to at least some extent. The evaluation means then preferably evaluates the architecture (in a quantified manner) via the architecture information preferably to determine its suitability for meeting the non-functional requirements.

Preferably, the apparatus of the present invention includes a simulator which simulates operation of modelled architecture utilising the model. A simulator preferably utilises the component and connection values to simulate operation of the model so that non-functional requirements such as performance can be evaluated. Non-functional requirements can therefore be assessed by the process of amending the requirements of the model and then simulating the performance of the model in meeting the amended requirements. If the performance is not satisfactory, the process then continues by engineering the model to change it enabling further simulation to see if the requirements are satisfied.

This architectural approach to the analysis of complex systems is novel. No one before has created a tool which utilises the architectural approach to analyse complex systems. A system developer can employ the rigour of an architectural approach and apply it to analysis of a complex system.

Preferably, the apparatus further includes a visualisation means which is arranged to create a visual representation of the complex system architecture from the stored architecture information.

Preferably, a plurality of different types of visualisation may be provided. They preferably include a three dimensional view (for example using spheres or tetrahedra to represent components and cylinders between the spheres or tetrahedra to represent connections). The three dimensional view is preferably hierarchical. The visualisation may also include a hierarchical tree view.

The visualisation means providing a plurality of different types of visualisation of the architecture advantageously enables a user to represent and evaluate different aspects of the complex system, much in the same way as in the built environment (eg. architectural approach to buildings), the scale model, mechanical drawings and electrical schematics allow architects and builders the ability to visualise different aspects of a building.

The visualisation is preferably able to be manipulated in a quantitative manner. Manipulation of the visualisation enables representation of different architectures which can subsequently be evaluated by the evaluation means to determine whether the amended architectures satisfy the organisations non-functional requirements.

Preferably, the visualisation means may also be used to facilitate loading of the architecture storing means with the architecture information. For example, in one further embodiment an interface is provided which enables a user to build a tree view of the architecture. The interface facilitates entry of architecture data in a tree view form.

The apparatus of a preferred embodiment of the present invention can therefore be used to facilitate a process which involves designing and visualising an architecture of a complex system, evaluating the architecture in terms of non-functional requirements for the system and also constraints that are required of the system (eg. only a certain amount of hardware may be affordable), and then to use the visualisation and evaluation to then effect (engineer) the architecture to change the architecture within the constraints in order to satisfy the non-functional requirements.

Preferably, the apparatus of the present invention enables the architecture to be modelled at different levels of detail. This can facilitate analysis of the architecture at different levels, for example at different levels within an organisation. This can be extremely useful. For example, at a very high level, a board of directors may only wish to view a high level of architecture to confirm that the system has the functionality they require for their organisation. They may wish to utilise the apparatus of the present invention to re-model the system at that very high level. At the other end of the scale, an implementation architecture may be required to be modelled by a software engineer who is implementing the software at the most detailed level. The apparatus of the present invention preferably enables the architecture to be modelled at any level.

Preferably, the apparatus of the present of the invention provides a means for modelling a capability space. The capability space model preferably provides a model of required system capability with respect to properties identified during analysis of the systems requirements. Preferably, the capability space comprises a frame of reference including axes drawn from properties that comprise the systems functional schema of the model. Capability space can be used to provide an indication of what is required of the system. Preferably, the apparatus enables determination of whether the architecture model fits within the capability space or whether further amendment of the architecture is required.

This apparatus operates as a tool which can be used to effect changes to a “real-life” complex system, after the changes have been modelled by the tool. Modelling can be done in an iterative fashion to arrive at the most optimum system for meeting the constraints and requirements and then the “real-life” system can be engineered. Using a tool such as this to evaluate and make changes to a real-life complex system is a novel process.

The apparatus of the present invention can be utilised by organisations acquiring a system to evaluate the system to determine whether it is likely to satisfy their requirements (evaluation). It can also be used by organisations to propose modifications to complex systems (either ones that they are acquiring or ones that they already have) in order to satisfy non-functional requirements. It can also be used by organisations developing complex systems in order to steer the development in order to ensure that the non-functional requirements are satisfied (engineering).

Preferably, the apparatus further includes engineering means for proposing changes to the architecture based on the evaluation, whereby to amend the architecture to enable optimisation to non-functional requirements.

Preferably, the apparatus of the present invention is implemented by appropriate computing hardware and software, in the form of a computing system.

In accordance with a second aspect, the present invention provides a method of analysing systems, comprising the steps of obtaining architecture information about the architecture of the system, and evaluating the architecture in terms of non-functional requirements of the system, utilising the architecture information.

In accordance with a third aspect, the present invention provides a method of evaluating a system, comprising the steps of utilising the apparatus of the first aspect of the invention to model the architecture of the system, and to evaluate the system in terms of non-functional requirements of the system, utilising the architecture information that has been modelled.

Preferably, where evaluation determines that the system does not sufficiently meet the non-functional requirements, the method of this aspect of the invention includes the step of proposing changes to the architectural model and re-evaluating. This step can be carried out in an iterative fashion until satisfaction of non-functional requirements is optimised. Once modelling is complete, preferably the method comprises the further step of engineering the modifications to the system.

In accordance with a fourth aspect, the present invention provides a method of developing a system, utilising the apparatus of the first aspect of the present invention, comprising the steps of defining a complex system architecture arranged to meet certain functional requirements, and evaluating the complex system architecture in terms of non-functional requirements.

Preferably, evaluation and re-modelling of the system architecture is carried out in an iterative fashion until non-functional requirements are optimised. Changes can then be made to the “real-life” system.

In accordance with a fifth aspect, the present invention provides a computer program arranged, when loaded onto a computing system, to cause the computing system to implement an apparatus in accordance with a first aspect of the present invention.

In accordance with a sixth aspect, the present invention provides a computer readable medium providing a computer program in accordance with the fifth aspect of the present invention.

### BRIEF DESCRIPTION OF THE DRAWINGS

Features and advantages of the present invention will become apparent from the following description of embodiments thereof, by way of example only, with reference to the accompanying drawings, in which;

FIG. 1 is a high level diagrammatic representation of an apparatus in accordance with an embodiment of the present invention;

FIG. 2 is a schematic block diagram illustrating a process for evaluating and/or engineering complex systems utilising the system of an embodiment of the present invention;

FIGS. 3 and 4 are diagrams illustrating an architectural model implemented in accordance with an embodiment of the present invention;

FIG. 5 through 9 are figures illustrating models implemented based on the architecture, for evaluating performance utilising an apparatus in accordance with an embodiment of the present invention;

FIGS. 10 to 14 is a representation of example visualisations provided by an apparatus in accordance with an embodiment of the present invention;

FIGS. 15 to 17 are representations of visualisations provided by an apparatus in accordance with the present invention to illustrate evolution of a complex system within an architectural space, and

FIG. 18 is a schematic diagram of a computer system implementing an apparatus in accordance with an embodiment of the present invention;

FIG. 19 is an illustration of a “generic” architecture for systems utilised in the insurance industry;

FIG. 20 is a diagram illustrating the required architectural space for an example system being analysed in accordance with an embodiment of the present invention;

FIG. 21 is a diagram illustrating an essential architecture of the example system;

FIG. 22 is an example “controller” display of a computer implemented embodiment of the present invention;

FIG. 23 is a display illustrating a “tree view” visualisation of the example system;

FIG. 24 is a display illustrating a plan view of the essential architecture of the example system;

FIG. 25A is an example display illustrating an elevation view of the essential architecture of the example system.

FIGS. 26 to 58 are various displays provided by an apparatus in accordance with an embodiment of the present invention to illustrate operation of the apparatus in relation to an example system being analysed by the apparatus.

### DESCRIPTION OF PREFERRED EMBODIMENTS

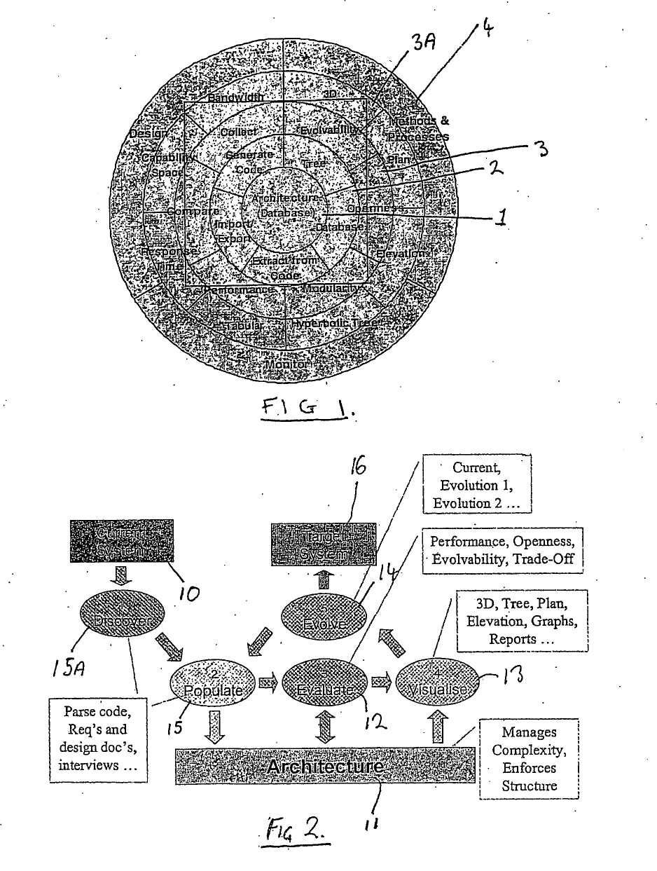

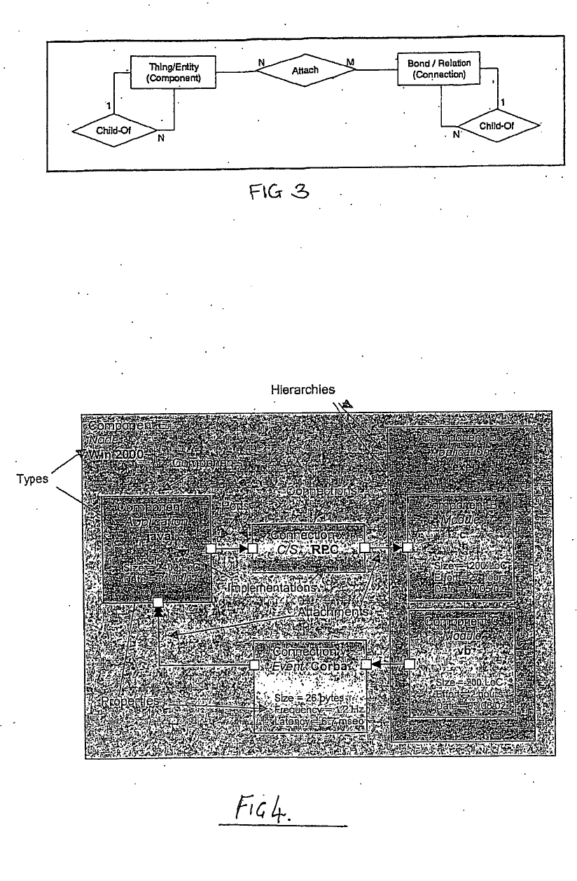

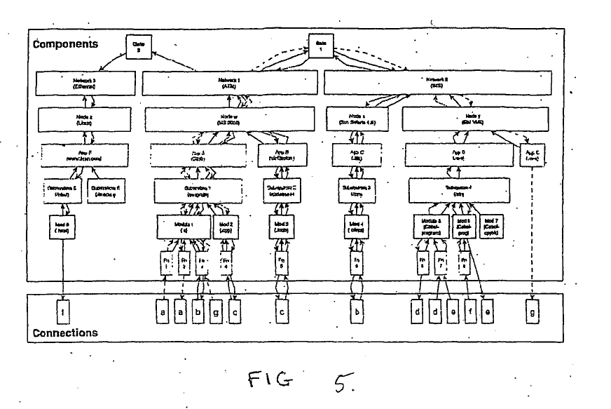

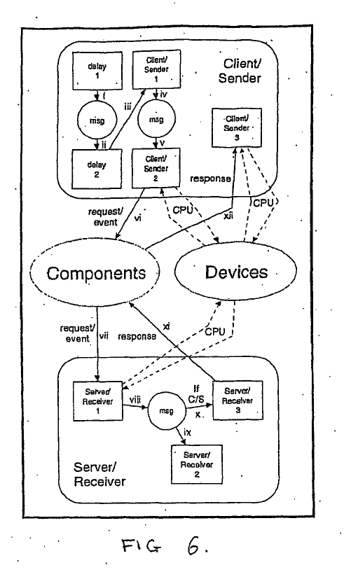

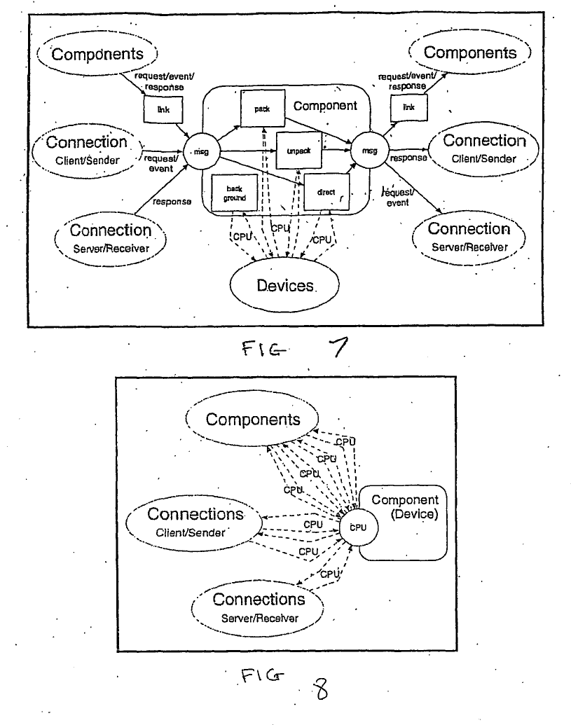

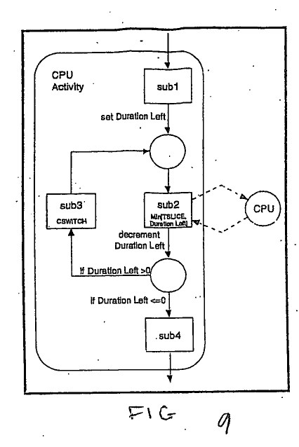

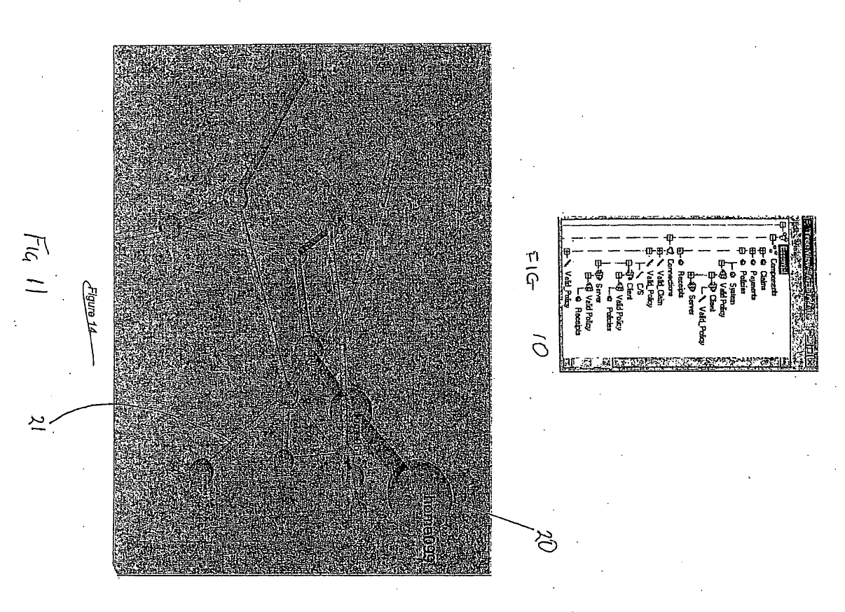

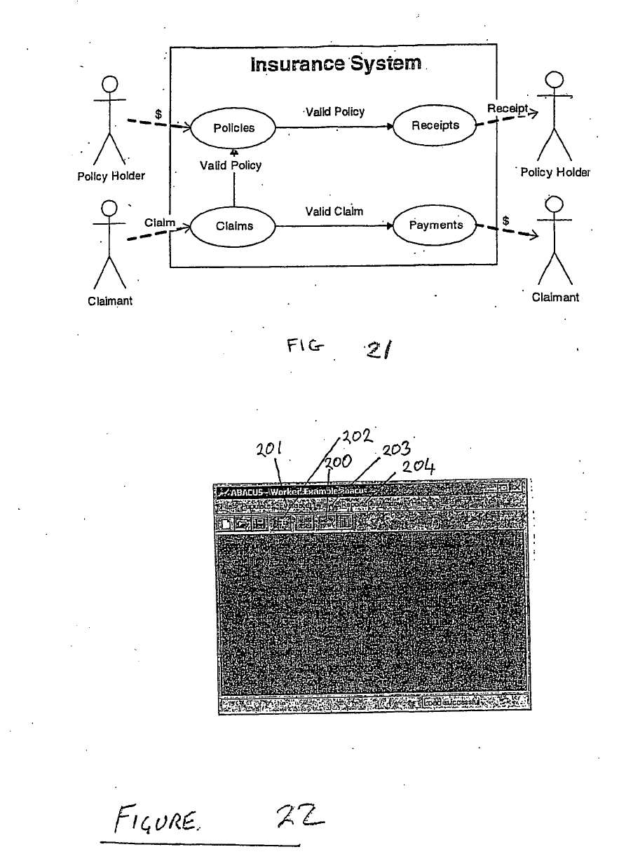

FIG. 1 is a schematic diagram representing a high level view of an apparatus in accordance with an embodiment of the present invention, this embodiment being a tool for analysis of a complex system, which can be utilised for the purposes of engineering (developing and amending) the complex system and/or evaluating the complex system. The tool may utilise any appropriate software/hardware platform to implement the tool providing the functionality as described in the following. In this embodiment, a computing system such as schematically illustrated in FIG. 22 is utilised to implement the apparatus. The computing system includes a computer 100 which incorporates conventional computing hardware, such as a processor(s) ROM, RAM, disc memory means. The system also includes a user interface comprising a keyboard 101 and mouse 102 for input, and a monitor 103 for display of information. It will be appreciated that the elements illustrated in the high level diagram of FIG. 1 to be described in the following, are implemented utilising appropriate software running on the computing hardware illustrated in FIG. 22. Any appropriate computing hardware may be used.

Referring to FIG. 1, the tool of this embodiment comprises an architecture storage means 1 including an architecture database for storing architecture information about the architecture of the complex system. The tool also includes a “populate” means 2 which facilitates population of the architecture database with the architecture information. It also includes an evaluation means 3 for evaluating the architecture in terms of the non-functional requirements of the complex system, utilising the architecture information stored in the storage means 1. As indicated in the figure the non-functional requirements may include any non-functional requirements, including evolvability, openness, performance and others.

The following description of the preferred embodiment deals specifically with an example where performance of systems is evaluated. The present invention may also be used, however, to assess other non-function requirements.

In this embodiment, the system further includes a visualisation means 3A which, in this example, is arranged to provide a plurality of different visual representations of the architecture of the complex system, including a hierarchical tree view, a hierarchical 3-D view, and tabular, database view. Other views may also be provided.

The system also provides an engineering means 4 which provides design information utilising the evaluation and visualisation layers for redesign of the architecture. The redesigned architecture can then be evaluated and visualised and again redesigned in an iterative manner until optimal satisfaction of non-functional requirements has been achieved in the architectural model. Methods and processes of engineering maintain an architectural focus according to architecture styles and principles to design and manage design.

FIG. 2 illustrates a process for utilising the tool of the present invention to evaluate and engineer complex systems.

An organisation may wish to purchase a complex system 10 (eg. a billing system) and wishes to evaluate the system to determine whether or not it meets the appropriate non-functional requirement of performance, etc. Utilising the tool of the present invention, the architecture of the current system 10 will be modelled, 11 and stored in the architecture storage means 1. The process of this embodiment of the present invention also utilises “discover” 15A and “populate” 15 steps. In the discover 15A step the current system 10 is examined by any number of techniques such as eg. parsing the code of the real-life system, interviewing system experts, etc. Knowledge of the system is then used to assist modelling and storage (populate) in the architecture storage means 1. In one embodiment of the present invention which will be discussed in more detail later, the architecture 11 provides three models of the architecture at different “levels” being the “essential” (high level), “intermediate” (medium level) and “implementation” (fundamental level). The architecture model of this embodiment of the invention is particularly advantageous, utilising particular structure, comprising “components”, “connections”, “devices”, “ports” and other elements. This will be described in more detail later.

In step 12, evaluation means 2 then evaluates the architecture 11 relative to the non-functional requirements of the target system 16 for the particular organisation. The visualisation means 3 generates visualisations 13 of the architecture which can also be used to assist the evaluation 12. The results of the evaluation can then determine, for example, whether the current system 10 is suitable for the organisation's needs.

Importantly, the evaluation and evolving of the systems is based on construction of an architecture 11 which is then used to evaluate, visualise, and evolve the system. The process is architecture-based.

An organisation may already have a system (the current system) which they wish to evolve to meet non-functional requirements that are presently not being met. The tool of the present invention can be utilised to model the architecture 11, evaluate and visualise 12 and 13, and then propose design changes 14 to the model which can then be re-evaluated 12 and 13 to determine whether it now satisfies the requirements. If the model satisfies the requirements of the system, then amendments can be made to the current system 10 in accordance with the newly modelled architecture 11, to arrive at the target system 16.

Further, the tool can be used in development of new systems. The target system 16, is modelled, evaluated 12 and visualised 13 and design 14 (evolve) changes are made to the model until the target system 16 satisfies the non-functional requirements of the system. It can then be built and tested, re-modelled utilising the tool of the present invention etc.

Each component of the system of the present invention will now be described in more detail.

1. Architecture

The architecture storing means is arranged to store information about the architecture of the complex system which is being assessed. The storage means preferably comprises a database and the architecture is stored in a relational form in the database. Further storage means (which in fact may be the same database) may also store system constraints (e.g. type of hardware that the system is limited to, and other limitations). In an alternative embodiment, the storage means may comprise a file arranged to run on appropriate software to provide the architecture.

The architecture may be defined in many different ways. In the preferred embodiment, the architecture of the complex system is represented as an architecture model. The architecture model of the preferred embodiment including “components”and “connections” between the components. The database may also store “constraints” which the system must obey. Components are things or entities e.g. in a billing system one component may be “receipting”. The connections are bonds or relations between components e.g. communication connections between components. Constraints include component/connection types, cardinality, performance etc.

The architectural based focus of the system of the present invention is very important in facilitating the analysis of the complex system. An architecture lends itself to assessment in terms of non-functional requirements. Further, architectural approaches that are used in more traditional areas where architecture is a focus (the construction industry) can be applied in the present system to facilitate assessment of the complex system.

The constraints define an architectural space within which limitations the complex system must remain if it is to operate optimally. Utilising the constraints, the system of the present invention defines the architectural space for the complex system.

One approach utilised in the embodiment of the present invention for modelling the architecture will now be described in detail.

Shown in FIG. 3 is a simplified Entity-Relationship diagram for the architectural model.

This E-R diagram shows that there are 2 types of entities; Things (Entities or Components) and Bonds (Relations or Connections) and 2 types of relationships; Child-Of and Attach.

In our model any thing (component) can be bonded (connected) to any other thing regardless of where the thing resides in the system hierarchy.

The first part of the structure of the system is captured in the “Child” relationships where any component (or connection) can be decomposed into any number of other components (or connections). These relationships will form two hierarchical trees that are related by the second part of the structure of the system, the “attach” relationship. Components and Connections are attached to each other to form the topology or structure of the architecture. Each connection can be between up to two components and components can participate in many connections.

The complete architectural model can be stated as follows:

“Architectures contain many Components and Connections of certain Types.”

“Components and Connections can be decomposed into Sub-Components and Sub-Connections.”

“Each Component is attached to any number of Connections via Ports but each Connection Port can only be attached to one Component Port.”

“Components and Connections have standard Implementations with standard Properties such as Data, Performance, Metrics, Visualisation etc.”

“Architectures, Components and Connections have specific Properties such as Data, Performance, Metrics, Visualisation etc.”
Components represent the entities of your architecture. For an insurance company, the components might be the systems for processing policies, claims, payments, and receipts.
Connections represent the relationships between these components. For example, in an insurance company, receipts are generated for valid policies, claims are made against valid policies, and valid claims result in payments. When thinking architecturally using this embodiment connections are as important as components, and they are dealt with in an almost identical way.

Connecting components can both have Properties. Properties are things like the way you require your system to perform, the number of lines of code it has, the percentage of these lines that are comments, etc.

FIG. 4 illustrates an example architecture model in accordance with an embodiment in the present invention, with five components and two connections. Components may include information on the components, for example component A is an Application which is in java and has a “size” and a “date”. A component D is an executable and includes within it modules component B and component C. Connection Y has a “size” a “frequency” and a “latency”. Using this information, performance of such a model can be simulated, so that non-functional requirements of the architecture can be evaluated.

The object model shown in FIG. 4 is hierarchical in nature to match the way the tool represents architectures of complex systems.

We can observe the following facts from the Object Model diagram:
The Object Model consists of Component Implementations, Connection Implementations, Component Types, Connection Types and specific Architectures
Component Implementations and Connection Implementations both have Properties
Component Types and Connection Types both have Ports
Architectures consist of Components, Connections and Properties
Components and Connections consist of Properties and Ports
Components and Connections can also contain Sub-Components and Sub-Connections respectively
Component Ports are attached to Connection Ports
A Component or Connection is of a specific Component Type or Connection Type and can be implemented by many Component Implementations or Connection Implementations respectively.

The architectural model also includes the concepts of hierarchies, ports, attachments, types and implementations.
By using Hierarchies (i.e. sub-components and sub-connections), you can hide information and de-compose your architecture. The architectural model is extremely flexible. Any component at any level can be related to any other component at any other level by any connection at any level.
Component and connection interfaces are called Ports. For components these are typically the methods that can be called or the services provided. For connections, a source/sink connection will have a source and a sink port (facilitating data flow from the source component to the sink component).
Attachment is the operation by which components are bound to connections (via their ports). For example, component A is providing data to component B. The source port of component A will be attached to the source port of the connection.
Components and connections are of a certain Type. This is mainly for classification purposes. For example components might be of the type ‘System’ or ‘Node’ and connections of the type ‘Transaction’ or ‘Client/Server’. The Type assigned to a component or connection provides a template for the ports, properties and implementations it has. For example, a Client/Server type connection has a client port and a server port. You can create your own new Types and assign your own combinations of ports, properties and implementations to them.
Standard libraries of properties can be specified and assigned to any of the other things in the architecture. These libraries are known as Implementations. By using Implementations, you only need to gather specific systems properties—the standard properties are already there. For example the standard performance characteristics of Microsoft Windows 2000™ can be assigned to whatever components are using the Microsoft Windows 2000™ operating system.

The extraction of the architecture from an existing system can be carried out by “parsers”, arranged to troll through the existing systems code (cobol, .net, java, XML etc) and extract the architectural elements (components and connections) and any relative properties (lines of code) etc. Parsers are provided with the apparatus of this embodiment of the present invention to obtain the information to construct the architectural model described.

The model of the architecture can also be built from other information discovered about the system, such as design documents, interviews with system experts (or indeed interviews with people that are not system experts but that will be using the system or are aware of the business processes which the system must carry out) etc. The information, whether obtained by automatic means such as parsing or human intervention, can be used then to populate the architecture storage database. In a preferred embodiment, the population of the database may be via an interface which is represented as a visualisation. For example, a tree structure (tree visualisation) may be provided for population of the database via input via the tree visualisation.

Further, the architecture can be modelled at various levels. At a very high level, for example, only the essential elements of the architecture model may be required. This high level may be useful at the appropriate level in the organisation which is associated with the system eg. management level, to discuss and confirm that the essential architecture of the system is correct and as desired. At a more fundamental level, an implementation model of the architecture may include all the connection components, including connections, and components at their most fundamental level. Providing these different levels of models facilitates a reasoned approach to non-functional properties such as performance.

2. Evaluation

Based on the architectural information, the evaluation means can evaluate the evolvability, openness, performance and other specified non-functional requirements of the system. The combination of algorithms utilising the architectural information data and visualisation (see later) analysis can be utilised to provide a quantifiable result for the non-functional requirements. In a preferred embodiment, the evaluation means includes predictive, assessment and experimental measures.

The following is a detailed example of the evaluation models utilised to predict the performance parameters based on the architectural information provided by the architectural layer.

FIG. 5 shows an example architectural model for the performance analysis of complex systems.

It can be seen in FIG. 5 that there are two types of networks that construct the performance model; Components (here seven layers of them) and Connections (the bottom layer). These are discussed as follows.

Connections

There are two “kinds” of connections: unidirectional (type 0—event etc) or bidirectional (type 1—client/server etc). a bidirectional connection involves two synchronous messages; a request message from the client to the server component and a response message in reply from the server to the client. A unidirectional connection involves a single asynchronous event message from the sender to the receiver component.

Messages (msg) that pass along the connections between the components in the architecture are modelled as message resources. The characteristics of each message resource are its source and destination components, request and response packet size in bytes (or event size for events), frequency, number of instances and client/sender and server/receiver processing duration in seconds. By modelling connections in this way the advantages of conditionally branching individual messages to different destinations, calculating activity durations for each individual message and an ability to model the “bursty” nature of multiple message instances, are realised.

Connections are attached to Components Ports and there are two types of ports a component can have; client/sender or server/receiver depending on the type of connection (client/server or event etc). Components consist of combinations of these types of ports depending on the connections they participate in. For example, one component may act solely as a client for a single connection while another “mixed” component may have client, sending and receiving ports for different connections.

Connections and the corresponding Component Ports are modelled with a network of conditional activities and queues connected directionally by links for each connection they participate in as shown in FIG. 6. Conditional activities are shown as rectangles, queues as circles, and resource flow paths as directed arcs. For clarity the message resource flow paths (shown with solid directed arcs) are numbered sequentially with roman numerals and only the CPU resource flow paths between the connection and its corresponding device are shown (with dashed directed arcs).

Each component's client/sender (o) port model for a given connection (c) consists of a network of two separate portions. The first portion either regularly or exponentially generates, after some random initial delay, a number of instances (I) of a request message or event (of size L_app1) for a connection at a specified frequency (f), processes them for a specified duration (S_app_o) and transmits them to the corresponding component. The random initial delay is introduced to prevent the unrealistic situation of all the components starting at precisely the same time. The second portion accepts from components, connection response messages (L_app2) destined for the component and processes them for a specified duration (also S_app_o).

Each component's server/receiver (p) port model for a given connection consists of a single network. The network accepts from the components, connection request messages or events (of size L_app1) destined for the component, processes the request message or event for a specified duration (S_app_p), discards it, and if it is a bidirectional connection generates a single response message and transmits it to the corresponding component.

By modelling the connections in this way the advantages of random application initialisation time, automatic sequencing of request/response messages and accurate inclusion of application service times, is realised.

Components

Components essentially accept messages from connections client/senders and forward them on to the next component on route to their destination connection server/receiver. Each component along the route packs, unpacks or passes through the message, adding or removing bytes to the packet along the way.

Components are implemented with standards such as CORBA and TCP/IP. For messages flowing up the component hierarchy (ie. away from their source) CORBA marshals application data into a common packet-level representation and conversely, for messages flowing down the component hierarchy (i.e. to their destination) CORBA unmarshals the packet-level representation back into typed data that is meaningful to an application. TCP and IP ensure the correct routing of messages across a network and the reliability and efficiency of a connection between two processes across a network. While TCP and IP also handle lost or out-of-sequence packets, for the purposes of this study, the occurrence of these anomalies is assumed to be negligible and as such TCP and IP will be assumed to also merely pack/unpack and forward messages.

Components are modelled with a network of conditional activities and queues connected directionally by links as shown in FIG. 7. Conditional activities are shown as rectangles, queues as circles, and resource flow paths as directed arcs. For clarity the message resource flow paths are shown with solid directed arcs and only the CPU resource flow paths between the component and its corresponding devices are shown (with dashed directed arcs).

Each component's model consists of a network of four (4) separate independent portions. The first portion accepts messages that need to be packed (i.e. flowing up the component hierarchy) from other components or connections, packs them and forwards them to their next component along the route (can't be packing to a connection). The second portion accepts messages that need to be unpacked (ie. flowing down the component hierarchy) from other components (can't be unpacking from a connection), unpacks them and forwards them to, their next component along the route, or connection. The third portion accepts messages that are just passing components (can't be direct from a connection), and forwards them to their next component along the route (can't be direct to a connection). The fourth portion represents the background processing (if any) on the component.

As a message is packed or unpacked, header/footer bytes are added or removed. TCP, for example, divides packets into segments. Each segment has a header field of 20 bytes (assuming that none of the rarely used TCP option fields is used). IP simply encloses a TCP segment in a single IP packet. Each IP packet has a fixed header size of 20 bytes, (assuming that the uncommon IP header option fields are not used), which contains address information for the destination node, etc. If Local Area Network Emulation (LANE) emulation is being used then messages are transmitted in frames. Each frame has a header filed of 22 bytes and a cyclic redundancy check (crc) footer of 4 bytes.

In summary, a packet sent over TCP/IP with LANE comprises of TCP segments encapsulated into a single IP packet which is in turn encapsulated into a single MAC frame. Therefore a component which is implemented with these communication standards would have the following header/footer added and removed when a message passes through it;

L_header=20+20+22+=62 bytes L_footer=4 bytes

The execution of the packing, unpacking and through activities is independent and the duration of each activity is a function of the characteristics of the message to be packed, unpacked or passed through. By modelling components in this way the highly variable duration of the packing/unpacking activities (which is dependent on the characteristics of the message being packed or unpacked) is accurately modelled.

Typical values (i.e. from CORBA) for the fixed (b) and variable (m) portions of the components service time for packing and unpacking a message can be expressed as follows;

| | |
|---|---|
| b_pack = 0.23 msec | m_pack = 0.13 usec/byte |
| b_unpack = 0.22 msec | m_unpack = 0.20 usec/byte |

The above equations show that the processing duration for each component is only affected by the size of the message. The connection data type (or structure) and the information content of the connection has been ignored.

The background processing is modelled with a fixed overhead per component. Observation has shown that the duration is typically a constant overhead of 3% for each node component type. Therefore the background overhead on a component can be expressed as follows;
k_{—}bkgd=30 msec/sec=3%
Devices

Devices provide processing capacity to components and connections. Specifically, for complex systems there is a need to schedule, share and multi-task multiple distributed CPUs between multiple distributed processes. Certain components contain a device and these are shared between all the other components and connections requiring processing capacity.

Processing capacity is modelled with CPU resources. The utilisation of a CPU is modelled with a network if a queue connected cyclically by links with each of the conditional activities in the components or connections requiring processing as shown in FIG. 8. Conditional activities are shown as rectangles, queues as circles, and resource flow paths as directed arcs. For clarity the CPU resource flow are shown with dashed directed arcs.

The queue holds the CPU resource while it is not in use by any other process. Processes requiring a CPU resource acquire it from the queue or if it is already in use will wait until it becomes available. By modelling the devices in this way resource sharing and most importantly contention is elegantly modelled in a single model.

Device sharing or multi-tasking is modelled by breaking every conditional activity that requires a CPU resource into small processing portions, allowing other activities a chance to run as shown in FIG. 9. Conditional activities are shown as rectangles, queues as circles, and resource flow paths as directed arcs. For clarity the message resource flow paths are shown with solid directed arcs and the CPU resource flow are shown with dashed directed arcs.

For each conditional activity that requires a CPU resource, the duration to process it is assigned initially to the total time and then decremented in fixed time slicing intervals (k_Tslice) with each iteration around a feedback loop. When the duration reduces to 0 the conditional activity terminates. Each iteration around the loop incurs a fixed context switching duration (k_Cswitch) corresponding to the device overhead required to swap executing processes.

The device time slice per task and task context switching are typically (ie. for MS Win 20000) as follows;

k_Tslice=20 msec k_Cswitch=1 usec/switch

by modelling the devices in this way an equal amount of CPU time is given to each concurrent conditional activity and hence no one activity can block any other activity.

Priorities are assigned to each conditional activity requiring processing accordance with the processing duration left for the activity. In this way a deadline monotonic (earliest deadline first or EDF) processor sharing (PS) scheduling algorithm is modelled. In a similar manner other PS scheduling algorithms (round robin or RR, first come first served or FCFS/FIFO) could be modelled. As it has been observed that the processing duration for messages on components is primarily a function of the size of the message, messages with a smaller size have a higher priority and are processed first. Larger messages have a lower priority and wait until smaller messages have been processed. Hence, by modelling the devices in this way, smaller messages are more likely to meet their deadlines at the expense of larger messages.

A critical reflection on the perceived benefits and the potential shortcomings of the architectural model against the model's features is provided in Table 1 below.

TABLE 1
Perceived benefits versus potential shortcomings

| Feature | Perceived Benefit | Potential Shortcoming |
|---|---|---|
| Conditional branching | More realistic than | None. |
| of individual | jobs being routed | |
| messages to different | based on | |
| destinations | possibilities. | |
| Calculation of | More realistic than | Information content |
| service | a single duration | and structure have |
| requirements for | per job type. | been ignored |
| each individual | | leading to possibly |
| message | | inaccurate |
| | | predictions. |
| Multiple instance | Understanding of | None. |
| messages | the bursty nature | |
| | of messages. | |
| Random application | Prevents the | Worst case scenario |
| initialisation | unrealistic | avoided. |
| | situation of all | |
| | applications | |
| | starting at | |
| | precisely the same time. | |
| Regular or | Accurately predicts | Exponential arrival |
| exponentially | a system's steady | rate may not solve |
| distributed | state with only a | the need for |
| arriving messages | single run. | multiple runs to |
| | | remove the regular |
| | | arrivals rates |
| | | exact symmetry. |
| Automatic | More realistic than | None. |
| sequencing of | two independent, | |
| request/response | out of sequence, | |
| messages | messages. | |
| Connection specific | Allows total | None. |
| application service | prediction of | |
| requirements | performance, not just | |
| | the infrastructure. | |
| Components highly | Accurate prediction | None. |
| complex and | of component | |
| variable service | performance. | |
| requirements | | |
| Distributed CPU | Processor sharing | None. |
| resource sharing | elegantly included | |
| and contention | into a single model | |
| | rather requiring | |
| | iteration between | |
| | two disjoint models. | |
| Fixed background | Accurate prediction | None. |
| processing overhead | of component | |
| on each component | loadings. | |
| Device multi- | Prevents messages | Only useful if |
| tasking and the | from blocking each | tasks require more |
| Processor Sharing | other and causing | than the device |
| (PS) scheduling | unrealistic waiting | time slice to execute. |
| algorithm | time. | |

Using the above models for evaluation a simulator can be implemented to simulate operation of the modelled system under various conditions to determine achievement of non-functional requirements. Results of the simulation can then be used to amend the system architecture to optimise the system and ensure that non-functional requirements are satisfied.

3. Visualisation

The visualisation means is able to present a plurality of different visualisation representations of the architecture of the complex system. It utilises appropriate computer software/hardware to provide a three dimensional hierarchical view: a tree view: a table/database view: a plan/elevation view. Other views can be presented as well.

The visualisations facilitate evaluation of the complex system. Because the system provides a plurality of different visualisations, this assists in the evaluation as the architecture can be evaluated from a number of different perspectives.

Example visualisations are shown in FIGS. 10 to 15.

FIG. 10 shows a tree view representing the hierarchical structure of a system architecture. FIG. 11 shows a three-dimensional view which can be generated by the apparatus of the present invention, showing architecture components 20, connections 21, and decomposition and properties indicated by colour coding and size.

FIG. 12 shows a tabular view of components.

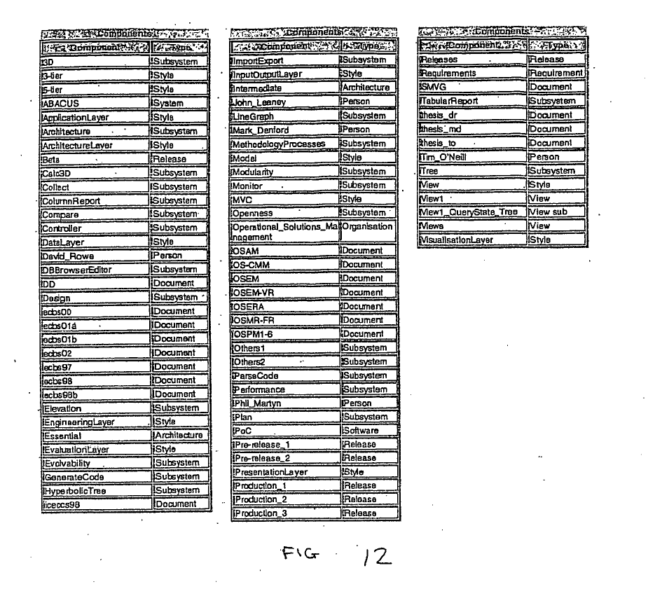

FIG. 13 shows a typical “plan” view of a system architecture. Dash lines raise synchronous connections (eg. events) while solid lines are asynchronous (eg. client/server).

The connection paths shown flow through the actual paths of the system that they “use” rather than the shortest line between the source and destination. For example connection f goes through the two gateways etc when it could have “logically” just been directly connected between module 8 and function 9 without any gateways at all.

FIG. 14 shows a typical “elevation” view of a system architecture.

The Connections are “instantiated” in the infrastructure. It can be seen that they fold down from the layers so that if they were viewed from the top they would look like they were between the components as per the architecture view.

In the 3D visualisation (and possibly others) elements may be shaped (eg sphere, cube, cylinder) to visualise a certain element, type, implementation or property of interest. For example a cube may illustrate one type of component and a sphere may illustrate another type of component.

Similarly elements may be coloured (eg green, yellow, red) to visualise a certain element, type, implementation or property of interest. Connect components, for example, could be coloured to show the certain property how it would be.

Further, common elements can be sized (eg radius, volume, length) to visualise a certain, element, type implementation or property of interest. For example the width of a connection may indicate a bandwidth property.

Preferably, the visualisation is hierarchical. Spheres may exist inside spheres, cubes inside cubes, cylinders inside cylinders etc.

Visualisation could also include opaque/transparent structures to show or hide their internal structures.

Elements may be freely attached eg any shape can be connected to any other shapes of any other level of the visualisation.

Further, the visualisation can optionally contain a horizon (eg sky versus ground) to maintain orientation.

4. Engineering

The system provides an engineering means which facilitate engineering changes to the architecture to facilitate compliance with non-functional requirements. The system includes algorithms which propose changes to architecture based on the evaluation.

The following example describes the use of the system in accordance with this embodiment.

Project Initiation

A large telecommunications carrier has decided that it needs to procure a new billing platform to support its complex billing structures for land line, mobile and satellite communications. It has learned from the horrendous expense of its last billing system (purchased as a commercial, off the shelf system, then extensively modified to suit local conditions) that the non-functional requirements, openness and evolvability of these systems is paramount to containing the costs of maintenance and enhancement, particularly given forecasts that billing regimes will have to become even more complex as customers have begun to understand the existing ones. It is also concerned about system performance under increasing load, and the new system's ability to interact with other applications.

The telecommunications carrier utilises an apparatus in accordance with the present invention to assess the architecture of the billing system in relation to non-functional requirements.

The telecommunications company specifies its requirements for the system. Requirements are broadly grouped as functional requirements (what the system must do), non-functional requirements (how well the system must do what it does) and constraints (the limits to freedom of design). Included in the non-functional requirements are those for openness, evolvability and performance. Included in the constraints may be architectural standards. Since the company wants to ensure that these requirements are met in the delivered system, it uses the apparatus of the present invention as a methodology for specifying these requirements in verifiable terms, and it also utilises the apparatus of the present invention to verify satisfaction of these requirements at various stages of the procurement.

Acquisition

The telecommunications company then follows its acquisition processes for supplier and product selection. Typically, a market survey of commercially available solutions will have been performed as part of requirements specification, since the commercial availability of “close-to-conformant” systems is a good indicator of the feasibility of requirements (including budgetary requirements). From this market surveys, and assessments of the capability of potential suppliers, a shortlist of suppliers and products/technologies will be developed.

The telecommunications company will use the apparatus of the present invention to assess the candidate products for openness, evolvability and performance as one of the selection criteria for a supplier and a system product, and having made a choice will let a contract to a supplier.

In this instance, the selected supplier proposes a solution which includes a product which requires customisation to meet the specific requirements. There will be a requirements analysis and solution design/implementation component to the supply of the system.

The evaluation of the proposed product for openness and evolvability, performance and other relevant non-functional characteristics (utilising the system of the present invention) tells the supplier and the buyer whether or not the desired functionality is feasible within the architectural constraints set by the proposed product, and whether the system which will result from the customisation of the product will meet the requirements for openness and evolvability. Some requirements may be modified or deleted as a result of this assessment. (Note that functionality of the proposed product would also be assessed, using a different methodology and toolset.)

The agreed non-functional requirements are baselined (i.e. a “snapshot” is taken, which can be used as the basis for negotiating change) and analysed for completeness, consistency, correctness and to eliminate ambiguity. These requirements may be stored by the supplier in the storage means of the apparatus of the present invention.

The supplier develops designs for the changes to the system, and uses the apparatus of the present invention as a design methodology and tool for modelling design alternatives, evaluating design tradeoffs and selecting an optimum device. The selected design is verified to confirm that the requirements for openness, evolvability and performance will be satisfied. The verified design is implemented in code, and the implementation is also verified using the apparatus of the present invention to confirm design characteristics have been delivered in the implemented system.

During this development activity, neither the requirements or the design remain static. New requirements emerge, existing requirements are changed. Design flaws are detected and corrected, design improvements are developed. The tool is used to guide design and to assess alternatives and verify achievement of design goals.

Acceptance, Production and Maintenance

The telecommunications carrier validates (using the tool) that the non-functional requirements for openness, evolvability and performance have been achieved before accepting system for delivery. The tool analysis and visualisations will also provide the insight into the architecture of the delivered system which will be used to plan how the system may evolve, and what resource and capabilities will be required to maintain the architecture.

Once the system is commissioned and placed in production, feedback (monitoring) from its use and changes to business requirements generate defect reports and change requests, which require further analysis and design, aided the by tool to implement. The tool also guides in the review and approval of change requests, since some changes may cause architectural degradation which will compromise the integrity of the system.

Over the period of its operational life, the system will be adapted or enhanced to meet new requirements (following a development lifecycle like the one used to build the system initially), and provided that these adaptations or enhancements are consistent with the “architectural space” of the system, the system will continue to perform and changes will continue to be feasible.

The tool provides the visualisation and evaluation capabilities necessary to identify the reasons for desired change, to provide information for selecting an optimal design for the change, and for analysing the consequences of the change.

If these changes cause the system to evolve outside the limits of its architecture, the system will degrade and its performance will be compromised.

The tool will be used as a key change management and design tool to ensure that architectural degradation is minimised, and to predict rates of degradation for the system and to assist with succession planning.

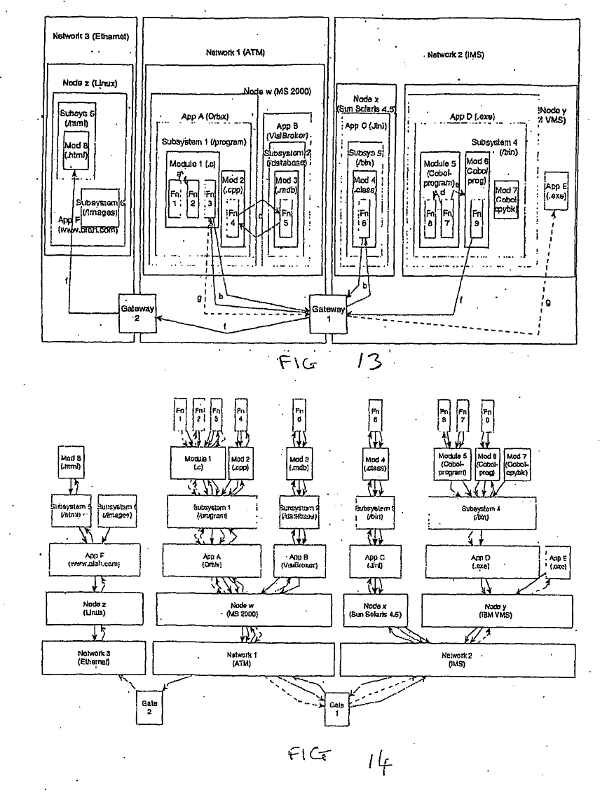

FIGS. 15 to 17 illustrate evolution of a complex system within its architectural space.

Referring to FIG. 15, a three dimensional view of the system architecture, is shown within evolutionary constraints (border 40). A problem exists in the interface 41 between the components on the top left and balance of the system as indicated by the connection 41. This problem could be a performance issue or a limitation on the ability of the interface to adapt to changing requirements.

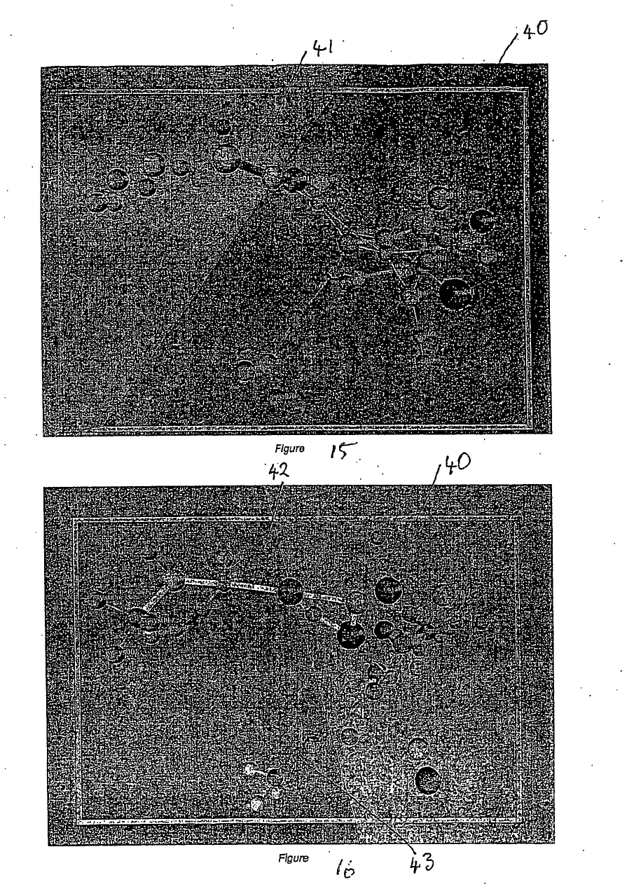

FIG. 16 shows a modified system architecture, showing resolution of the problem identified in FIG. 8 at reference numeral 42 and the emergence of other risk areas 43. Note that the architecture is now also close to the boundaries of its architectural space 40 in several areas.

FIG. 17 illustrates architectural degradation, with sub-systems 44, 45 no longer suitable for use (outside constraints 40).

Example Development of System

The following example illustrates how a simple system for the insurance industry can be developed utilising the system of the present invention.

Requirements

Requirements form the baseline of the system to be developed, hence this first phase of the process influences the entire analysis and systems engineering project. The requirements may be documented (poorly or appropriately), verbal (drawn out by discussion) or implicit (in which case they stay hidden until often too late in the project). Nonetheless, requirements analysis is a first step of the engineering process.

Generic Architecture

Various “generic” architectures for the insurance industry exist with a widely applied one being the IBM Insurance Application Architecture (IAA) shown in FIG. 19.

This architecture for the purpose of this example can be simplified into the following four areas;

1. Policies—Initially, increasing volumes of “short-tail” policies (and hence claims) such as Motor, Home, Compulsory Third Party (CTP), Health and Life but eventually expanding core business to include “long-tail” susceptible policies (where peril occurs during coverage period but claim is made many years later) like Workers Compensation (WC), Public Liability (PL) and Professional Indemnity (PI).

2. Receipts—Generated when a valid policy is started.

3. Claims—Made against valid policies for compensation.

4. Payments—Paid to claimants for valid claims against valid policies.

Essential Requirements

The first stage in the process of this embodiment of the present invention is to gather the essential requirements of the system under study. The requirements are ideally drawn from a detailed requirements analysis phase performed according to best practice. Requirements are drawn from a well documented System Requirements Specification (SRS), interviews with key designers and/or the as-built system (for example by parsing code from the as-built system). The method of obtaining the system requirements will vary depending upon the state of the system under study. For example, if the system has not yet been built, there will be a different approach to obtain the requirements than for a system that has already been built and is being further developed or merely examined.

For simplicity, however, the essential requirements for the Insurance System are simply listed as follows;

The insurance system shall handle;
1. Motor short-tail policies, receipts, claims and payments resulting in a rate of 20,000 transactions/hour.
2. Home short-tail policies, receipts, claims and payments resulting in a rate of 5,000 transactions/hour.
3. CTP short-tail policies, receipts, claims and payments resulting in a rate of 15,000 transactions/hour.

The insurance system shall be implemented with;
1. A single 1250 MIPS node/cluster.
2. IBM (IMS, MVS etc) and communication (TCP/IP) standards.
   Requirements State Space (RSS)

The next stage of the process is to formally express the requirements for the system under study.

The requirements state space provides a model of the required system in terms of the properties, constraints and capability identified in the requirements statements. It is a state space because it plots key variables, connected to the companies KPIs (Key Performance Indicators), against each other. Consequently, it is proposed that a system's requirements be represented as a capability space. Intuitively, the space will provide a model of required system capability with respect to properties identified during system requirement analysis. More formally, the space is constructed within a frame of reference whose axes may be drawn from properties that comprise the system's functional schema model.

The requirements state space (RSS) for the insurance system is shown in FIG. 30. The two axes chosen are the combined transactions/hour that result from the insurance system's ability to process policies, receipts, claims and payments and the initial insurance system's “short-tail” policy types; namely Motor, Home and CTP. The points on the line are obtained from company records. The line also implies the rate of growth of the system over time, and the shaded area designates the total space which is covered by the requirements.

Current System—Essential Architecture

The essential architecture utilises abstraction to help highlight key system properties, architectural components and component interaction. The essential architecture model is a primary tool in ensuring that the system is capable of meeting its requirements as the architecture has a fundamental influence of the system's functionality, performance and quality (including evolvability). Further essential modelling concepts may be drawn from systems engineering and systems theory literature to help establish the essential model. The tool of this embodiment of the present invention is used to formalise the concepts associated with the essential model and then provides a basis on which to reason about the feasibility of the proposed architecture.

Model

The next stage of the process is to model the system at the essential level, identifying the minimal set of components and structure necessary to satisfy the requirements. Essential things are a direct reflection of the essential functional requirements (thus retaining the abstraction required at the architectural level).

The essential architecture for the Insurance System is shown in FIG. 21.

FIG. 21 shows the four essential areas identified previously and the interaction between them. Potential policy holders initiate new policies and existing policies are updated. Receipts are generated for valid policies and sent to policy holders. Claimants make claims against valid policies for compensation and valid claims result in payments to claimants.

Populate Essential Architecture

The next stage of the process is to populate the architecture storage means 1 with the essential architecture developed in the previous stage.

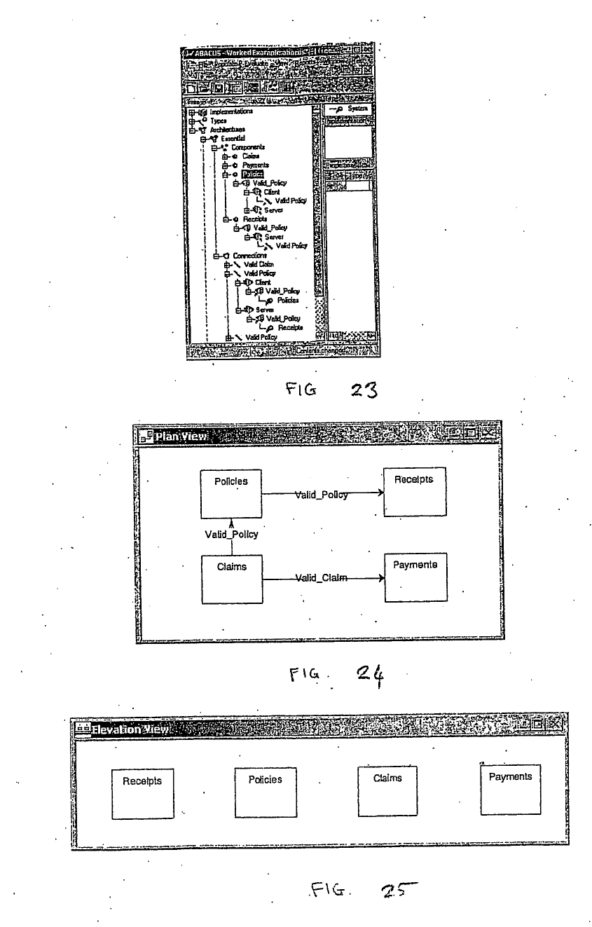

An “Essential” architecture version is added and the top level of the essential architecture is directly entered into the tool using the Controller and Tree View as shown in FIG. 22 and FIG. 23.

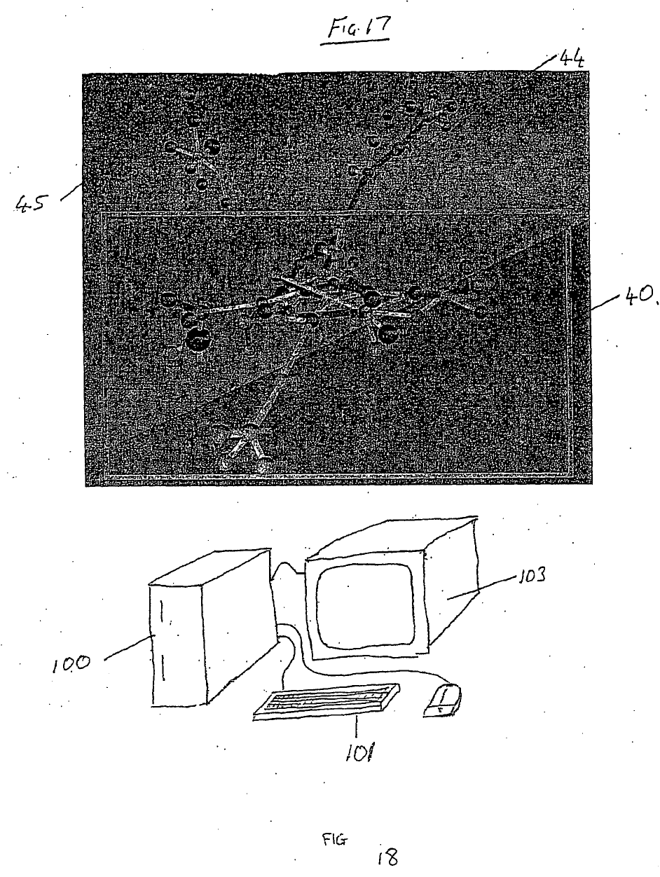

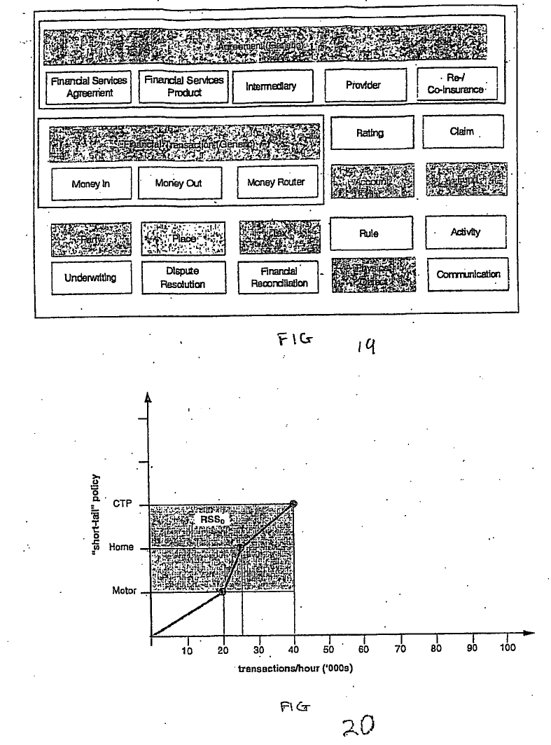

FIG. 22 illustrates a example display as may appear on computer monitor 103 of FIG. 18. FIG. 22 essentially illustrates a main menu of the tool of this embodiment. The controller includes menus for visualisation 200 evaluation 201 and architecture 202. Each of these menus includes sub-menus eg. visualisation 200 includes a “views” menu 203 from which a user may select various views of the architecture and a “reports” menu 204 from which a user may select various reports.

FIG. 23 is an example display illustrating a tree view of the essential architecture of the insurance system of this example. The tree view acts as a tool enabling a user to enter the architecture into the view as illustrated in FIG. 23. The system may also be utilised to enter the architecture via various other views. The tree view has been used here as being convenient.

View Essential Architecture

Having populated the tool with the essential architecture the next stage of the process is to visualise the architecture from various viewpoints.

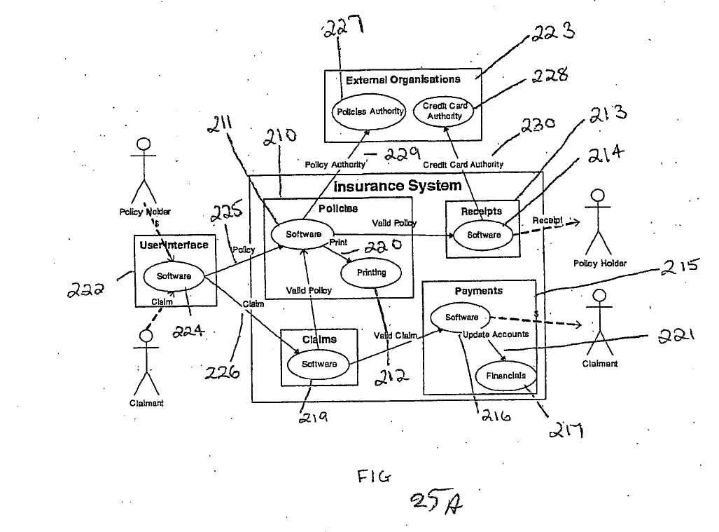

The 2D Plan and Elevation Views are shown in FIG. 24 and FIG. 25. It should be noted that as there is only one level of hierarchy in the Essential Architecture the ABACUS Elevation View (see FIG. 25) is “flat”.

Current System—Intermediate Architecture

The intermediate architectures describe the system in successively more detail than the requirements driven essential architecture. The intermediate architecture models are a primary tool in refining the system down to a subsequent implementation architecture that is capable of meeting the system's functionality, performance and quality (including evolvability) requirements. the system of this embodiment of the present invention is used to formalise the concepts associated with the intermediate models and provides a basis on which to reason about the feasibility of the proposed architecture.

Model

The next stage of the process is to model the system at successive intermediate levels (here only one for simplicity), viewing the system as a more and more detailed collection of interrelated components from which the final system design and implementation may be reasoned about.

The essential architecture described in the previous section is expanded to include;

Two additional major areas; User Interface and External Organisations

Full functional details of each major system (the full functional details of the areas could be extracted from the real system using a parser which forms part of the system of this embodiment of the present invention).

This intermediate architecture is shown in FIG. 25.

It can be seen from FIG. 25 that the components of the essential architecture have now been detailed to show sub-components. For example the policies component 210 includes a software 211 sub-component and also a printing 212 sub-component. Receipts 213 includes a software sub-component 214. Payments 215 includes a software component 216 and a financials component 217. Claims 218 includes a software component 219. Further connections are also included where the further sub-components merit this. The software 211 and printing 212 sub-components of the policies 210 component include a print 220 connection. Similarly, the payments components 215 includes an updated accounts 221 connection between software 216 and financials 217.

The system has also been extended to include a user interface component 222 and an external organisations component 223. The user interface component 222 includes a software 224 sub-component and connections policy 225 and claim 226 between the software sub-component 224 of the user interface 222 and the software sub-components 211 and 219 of policies 210 and claims 218, respectively.

Similarly, the external organisations component 223 includes a policies authority 227 and credit card authority 228 sub-component, with connections plus the authority connection 229 and credit card authority connection 230 from the software 211 and 214 sub-components of policies 210 and receipts 213 respectively.

It can be seen that the modelling process results in the realisation of components and connections which can be evaluated for non-functional requirements, such as performance, etc, using the tool of the present invention.

Populate Intermediate Architecture

The next stage of the process is to populate the tool with the intermediate architecture developed in the previous stage.

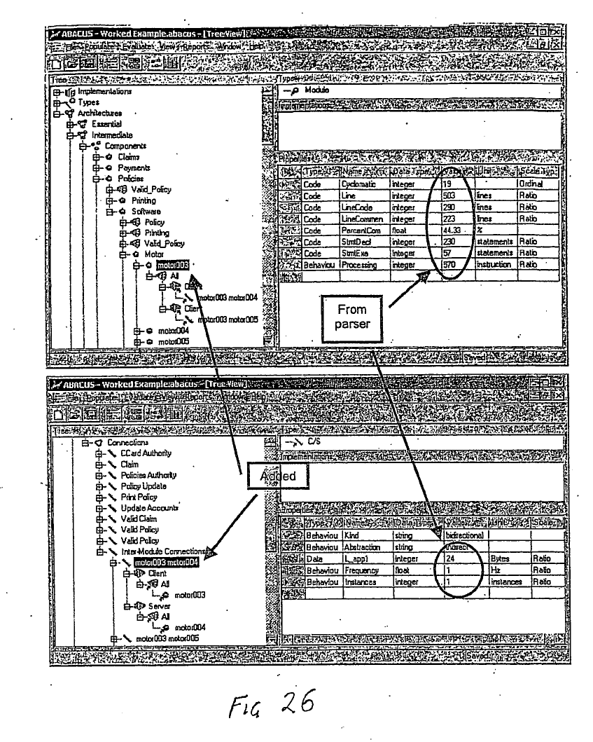

Using the Tree View the entire “Essential” architecture version is copied and renamed to a new “Intermediate” architecture version. The two additional systems (User Interface and External Organisations) plus the first level of decomposition of each system into applications is also entered as shown in FIG. 26.

Having populated the tool with the upper levels of the intermediate architecture the next stage of the process is to extract the lowest level details of the system using the parser component.

The parser of the tool of this embodiment is used to gather the lower level details of each application into subsystems and modules (of code) together with associated properties (LoC, % comments etc) as shown in FIG. 26.

View Intermediate Architecture

Having populated the tool with the entire intermediate architecture the next stage of the ABACUS process is to visualise the architecture from various viewpoints.

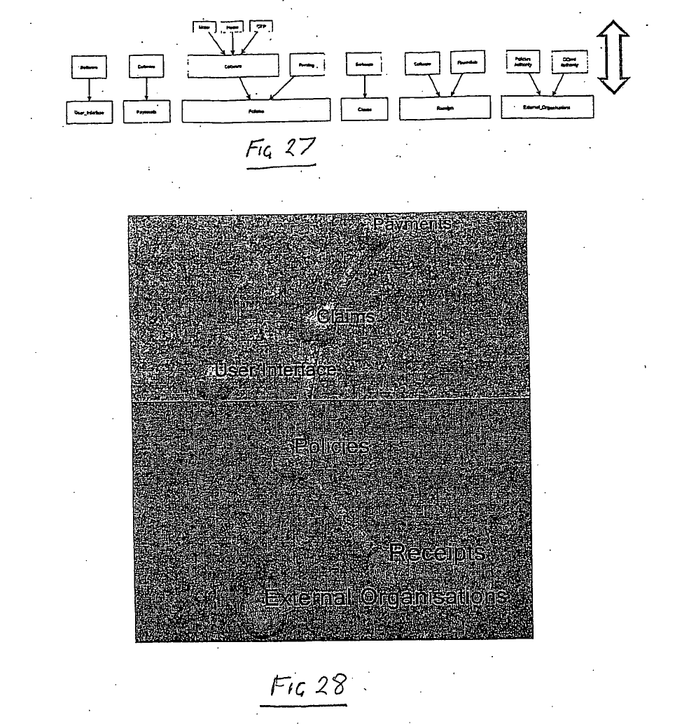

The 2D Elevation View is shown in FIG. 27. FIG. 27 shows that a further 2 levels of hierarchy have been added to the essential architecture by the intermediate architecture.

As the architecture is getting more complex it is necessary to start to use more advanced visualisation techniques such as 3D. 3D Views of the Intermediate Architecture are shown in FIG. 28 and FIG. 29.

FIG. 24 is a “close up” of the policies 210 component. The visualisation visualises the policy component as a sphere. Within the sphere the sub-component 211 of the policies 210 component is illustrated. It can be seen that the software sub-component is also broken down into further components in connections within the software. It can be seen that this is a convenient way of visualising the hierarchy within the architecture.

Current System—Implementation Architecture

A system's essential and intermediate architectures are fundamental viewpoints, however they do not consider the system solution sufficiently with respect to implementation issues—it is the actual component recipe (i.e. the characteristics of the components used and their interaction) that delivers the final, specified functionality and capability. Implementation issues to be considered here include allocation of functional components to physical components (i.e. design synthesis), high-level implementation issues such as choice of design philosophy (e.g. utilising messaging for communications versus client-server) and possible technology solutions. The tool of this embodiment of the present invention is used to ensure that the architectural solution chosen is appropriate and feasible given the skills and technology available. The resulting model is that of the implementation architecture.

Model

The next stage of the process is to model the system at the implementation level, viewing the system as a collection of interrelated components from which the final system design and implementation may be reasoned about. The focus is on the level of implementation detail critical to the success and evolvability of the system. The specific implementations for each system and subsystem are included as follows;
Single Core Network with 1250 MIPS processing Cluster/Node.
Single External Organisations Network and Node.
Single User Interface Network and Node.
IBM and TCP/IP standards for interfaces.
   Populate Implementation Architecture

The next stage of the process is to populate the tool with the implementation architecture developed in the previous stage.

Using the Tree View the “Intermediate” architecture version is copied and renamed to a new “ImplementationA” architecture version. Using both the Tree Views (Architecture and Types) the physical components (networks and nodes) plus the standard implementations of each are also entered as shown in FIG. 30. Also shown in FIG. 30 are the results of the performance simulation which is discussed in the following section.

Evaluate Implementation Architecture

Having populated the tool with the implementation architecture the next stage of the ABACUS process is to simulate the system using the tool performance simulator component.

Now that the implementation architecture components (i.e. physical networks and nodes) have been added the tool's performance simulator can be run. It predicts that the Core Networks cluster/node is running at ˜56% (as seen in FIG. 30) which is around 700 MIPS and that there are correctly 40,000 transactions/hour or 11.11 transactions/second (NB: 2000 transactions/hour or 0.55 transaction/second are not seen by the cluster/node as they are internal to the policies and payments systems resulting in the cluster message rate shown of only 10.56 transactions/second).

Having populated and simulated with the implementation architecture the next stage of the process is to visualise the architecture from various viewpoints. The 2D Elevation View is shown in FIG. 32.

It can be seen from the results in FIG. 30 and the Response Time Chart in FIG. 31 that the response times for the connections are well within their deadlines (ie 1/frequency).

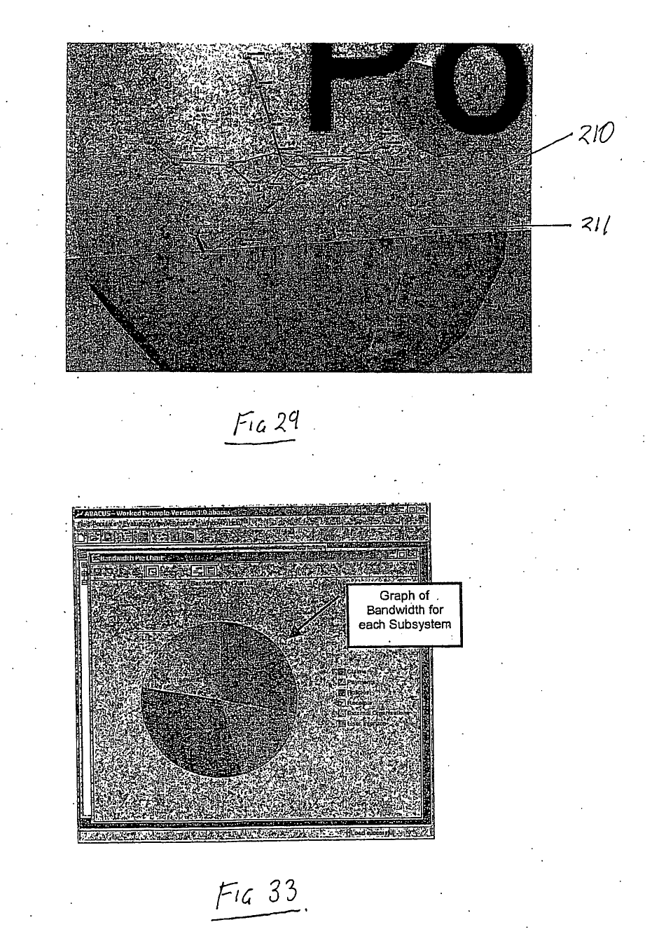

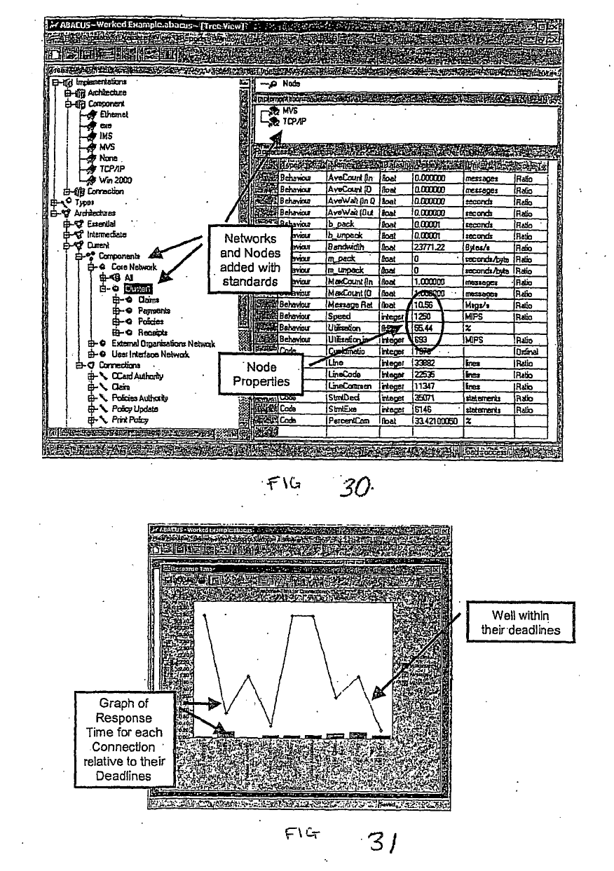

The system Bandwidth Pie Chart shown in FIG. 33 shows that the Claims and Policies systems are consuming the most bandwidth in the overall system.

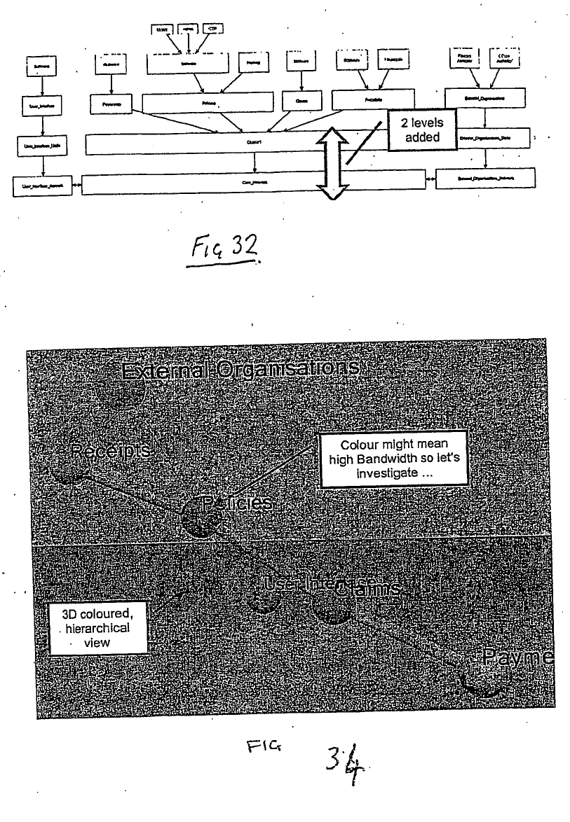

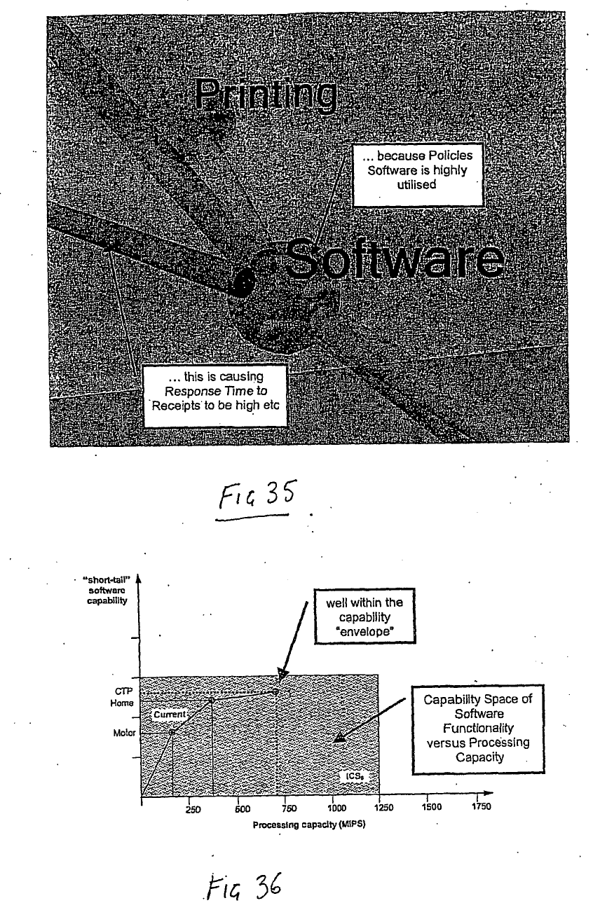

3D views of the implementation architecture, showing issues that are arising, are shown in FIGS. 34 and 35.

While a system's implementation design will be based on an architectural design with demonstrated capability, the actual system implementation will introduce further complexity (in the way of composition and structure) and constraints. This may result in possible architecture capability not being achieved. Alternatively, the implementation of a system may bring unanticipated capability, or properties not designed for. For this reason it is necessary to consider a system capability space which takes into account implementation factors and constraints. As we are most interested in establishing the implementation's ability to fulfil the required system capability, the next stage of the process is to develop a refined understanding of system capability via the system's Implementation Capability Space.

The Implementation Capability Space (ICS) for the short-tail software capability and the resultant processing capacity (MIPS) is shown as a Capability Space Chart in FIG. 36. For the two properties it can be seen that the current system is well within the capability envelope. However, one can estimate how long it will be before the system becomes dangerously close to the envelope, and thus better manage any required upgrades.

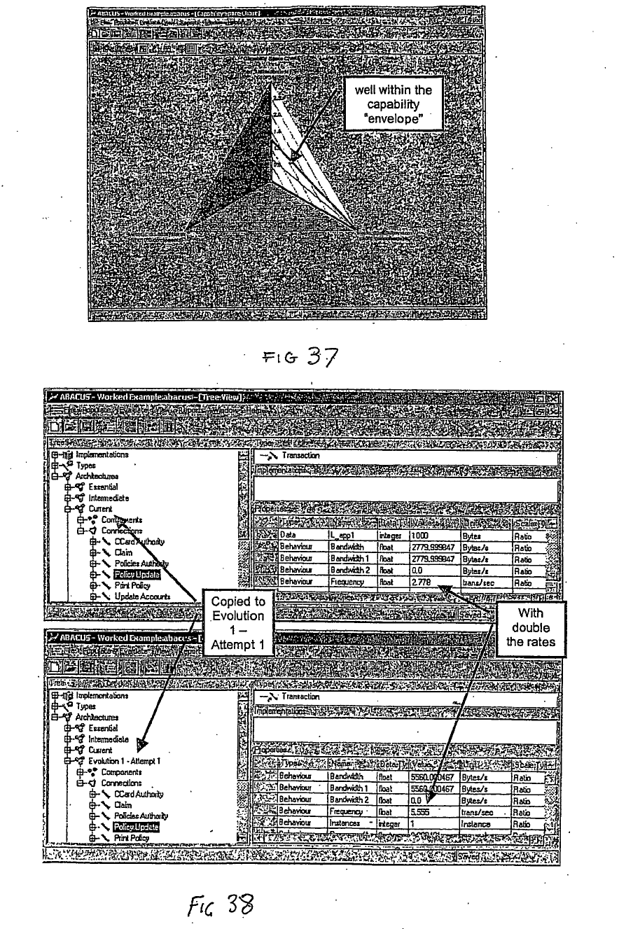

The tool visualises Capability Space using radar graphs, as typically more than two properties need to be open “tracked”. The corresponding Capability Space Radar for FIG. 36 is shown in FIG. 37.

The current architecture has now been developed (populated, evaluated and viewed) so the next sections look at evolving it into a desirable target system.

Change Analysis

Remaining consistent with current best practice regarding architecture analysis and evaluation, a system's evolvability in the process is evaluated with respect to specific change scenarios. The scenarios provide an appropriate context that highlights the likelihood, type and degree of change expected. It is from this perspective that the impact of change and the system's ability to cope with such changes are meaningfully reasoned about within the tool of the present invention.

The next stage of the process is to establish the change scenarios or evolutions for the system. Three change scenarios/evolutions are identified for this example;
1. Increased volume of existing Motor, Home and CTP “short-tail” transactions.
2. Expansion of business to include additional Health and Life “short-tail” policies
3. Expansion of business to include long-tail susceptible WC, PL and PI policies.
   Target System—Evolution 1
   Detailing the Evolution
   Double the number of transactions for each of Motor, Home and CTP.
   Populate Evolution 1—Implementation A

The next stage of the process is to populate the tool with the implementation architecture for the system evolution detailed in the previous stage.

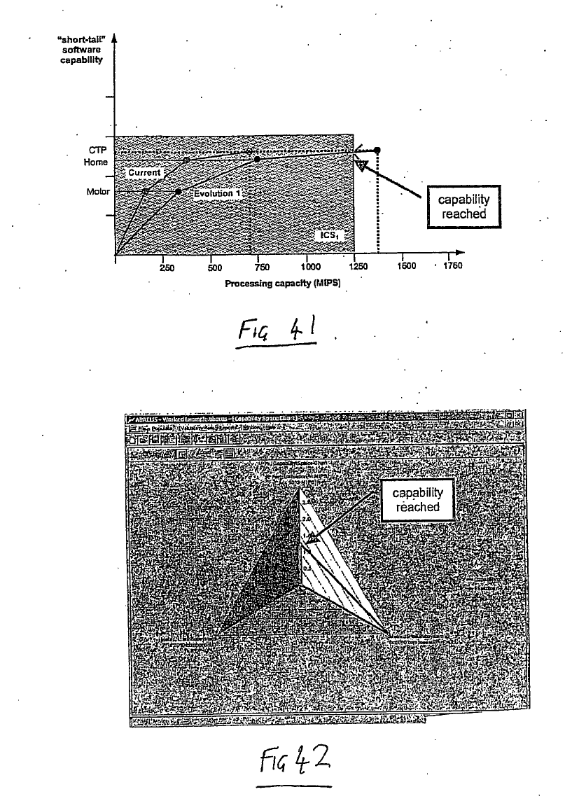

Using the Tree View the “Current” architecture version is copied and renamed to a new “Evolution 1—Attempt 1” architecture version. The frequencies for each of the connections are doubled using the Tree View as shown in FIG. 41.

Evaluation Evolution 1 (Attempt 1)

Having populated the tool with the implementation architecture for the evolution the next stage of the process is to simulate the system using the tool's performance simulator component.

The performance simulator is re-run. It predicts that the Core Networks cluster/node is fully saturated and running at 100% and not surprisingly various connections have a throughput less than their frequencies meaning that they are not getting through and the system is overloaded.

View Evolution—1 (Attempt 1)

Having populated and simulated the tool with the implementation architecture for the evolution the next stage of the process is to visualise the architecture from various view points.

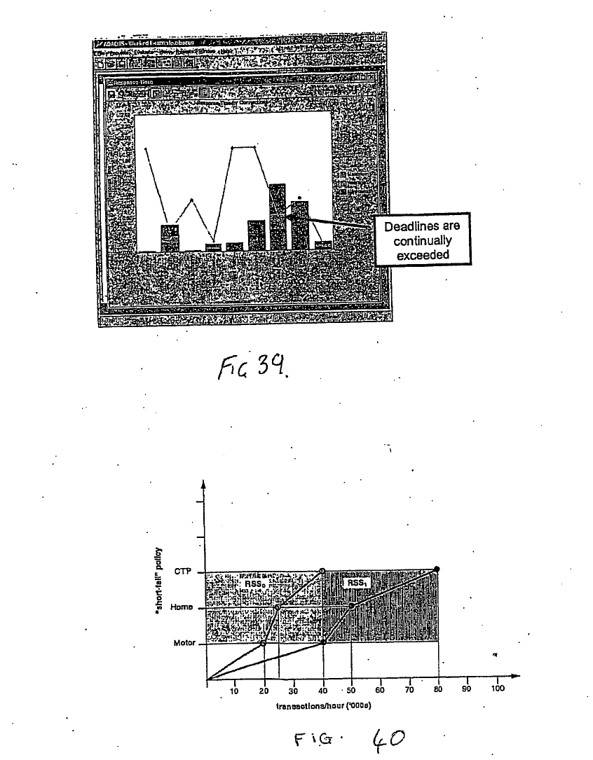

It can be clearly seen from the Response Time Chart in FIG. 39 that the Response Times for the some of the connections continually exceed their deadlines (i.e. 1/frequency).

The requirements creep for Evolution 1 within the Requirements State Space (RSS) is shown in FIG. 40. RSS₀ corresponds to the current system which handles Motor, Home and CTP short-tail policies etc at a capacity of 40,000 transactions/hour. RSS₁ represents a change to RSS₀ with an additional 40,000 transactions/hour.

Evolution 1 within the Implementation A Capability Space (ICS) is shown as a Capability Space Chart in FIG. 41. The first stage of scenario 1 is a generality (see below) change, within ICS_{A} spare capacity. Then the boundary is hit when the processing capacity of 1250 MIPS is reached. The second stage of scenario 1 requires an adaptability change to ICS_{B}. Here the processor is upgraded to a faster 1750 MIPS processor. This is detailed in the following section.

Generality, adaptability, scalability and extensibility define levels of a taxonomy of change, or evolution. The cost of change at each named level is in general more costly than the preceeding level. Generality only requires internal change to the current change; adaptability requires some component swapping; scalability requires the addition of similar components plus the requisite infrastructure; extensibility requires a whole new dimension of growth to be added.

The corresponding Capability Space Radar for FIG. 41 is shown in FIG. 42.

Populate Evolution 1 (Attempt 2)

Having discovered that Implementation A has insufficient capability for Evolution 1 the next stage of the process is to populate the tool with a revised implementation architecture with hopefully sufficient capability.

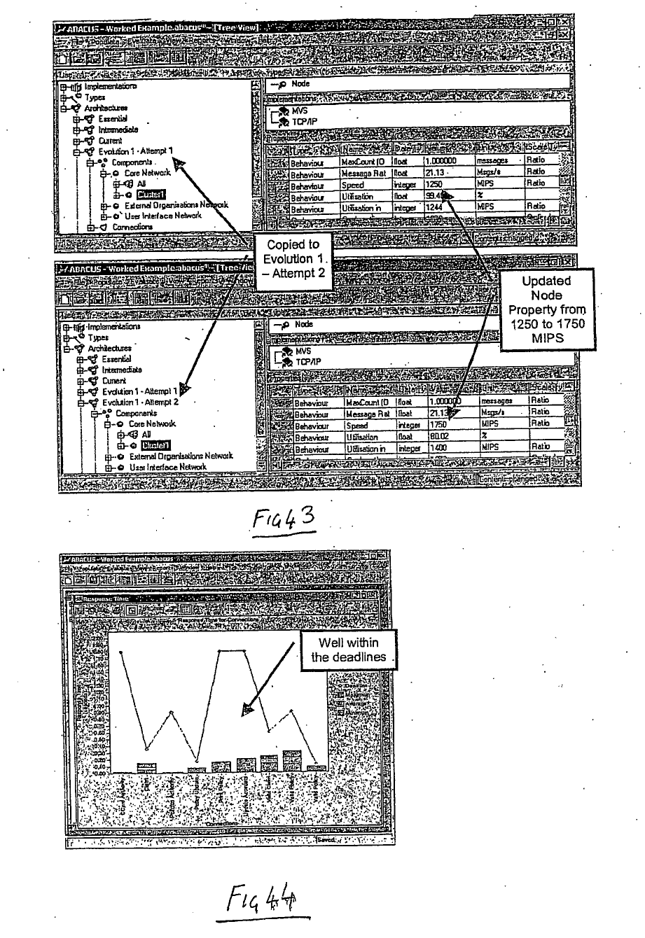

Using the Tree View the “Implementation 1—Attempt 1” architecture version is copied and renamed to a new “Implementation 1—Attempt 2” architecture version. The speed of the cluster node is updated to 1750 MIPS and the corresponding service times (s_app Property) for the applications on the node are automatically re-scaled (from the corresponding Processing property) to match this new speed. These changes and the result of the re-run performance simulation (discussed later) are shown in FIG. 43.

Evaluate Evolution 1—(Attempt 2)

Having populated the tool with the revised implementation architecture for the evolution the next stage of the process is to simulate the system using the performance simulator component to see if it is capable of meeting the evolutions requirements.

The performance simulator is re-run as shown in FIG. 43. It predicts that the Core Networks cluster/node is running at ˜80% which is 1400 MIPS and that there are correctly 80,000 transactions/hour or 22.22 transactions/second.

View Evolution (Attempt 2)

Having populated and simulated with the revised implementation architecture the next stage of the process is to visualise the architecture from various view points to see if the revised architecture meets the evolutions requirements.

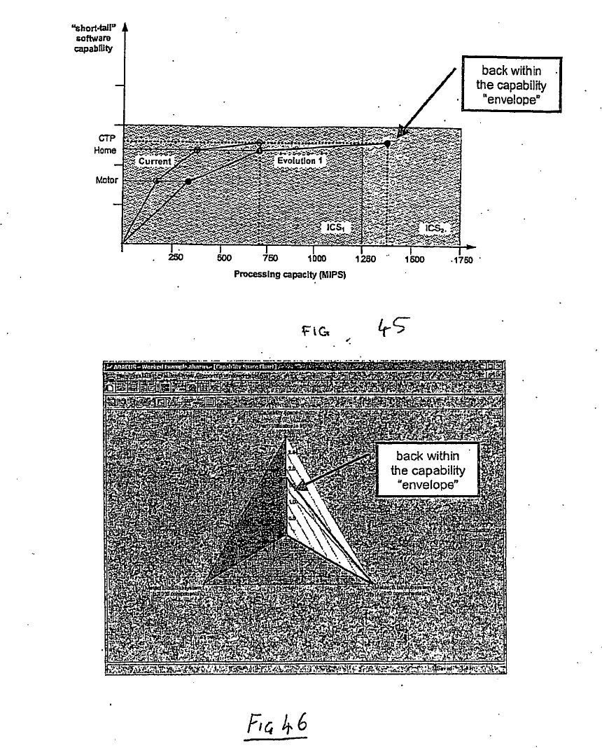

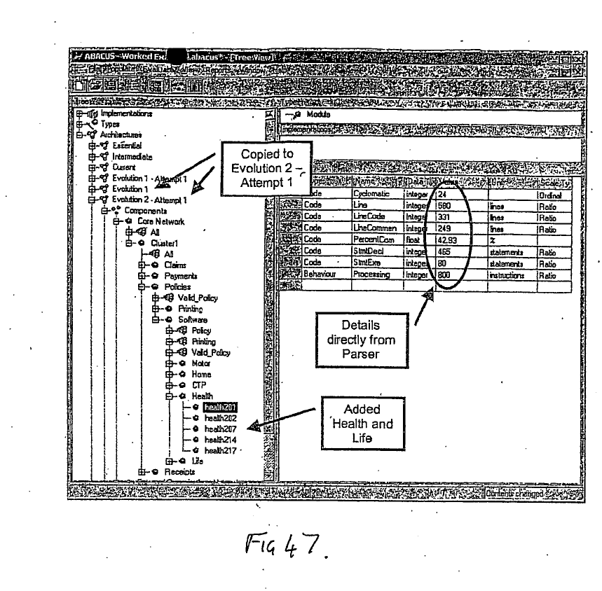

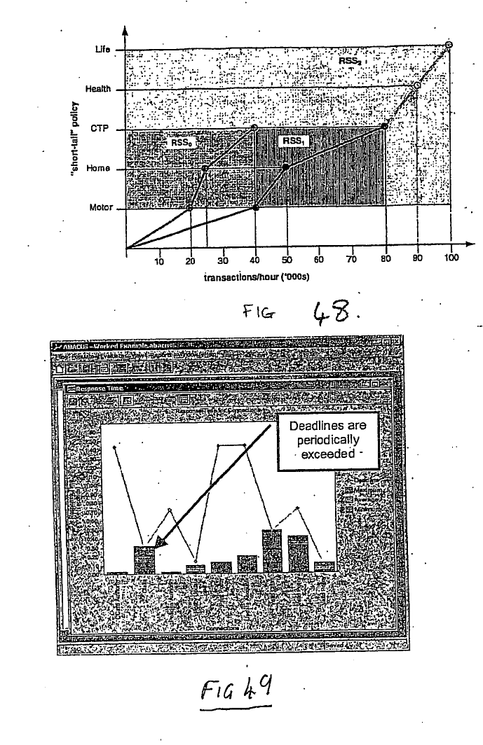

It can be seen from the Response Time Chart of FIG. 44 that the Response Times for the connections and the revised implementation are well within their deadlines (ie 1/frequency).

Attempt 2 within the Implementation Capability Space (ICS) is shown as a Capability Space Chart in FIG. 45. FIG. 45 clearly shows that “Evolution 1—Attempt 2” is capable of meeting Evolution 1's requirements and this successful architectural evolution attempt is renamed to “Evolution 1”.

The corresponding Capability Space Radar for FIG. 45 is shown in FIG. 46.

Target System—Evolution 2

Detailing the Evolution

Additional Health and Life short-tail policies, receipts, claims and payments with a resultant additional 20,000 transactions/hour.

Populate Evolution 2 (Attempt 1)

The next stage of the process is to populate the tool with the implementation architecture for the system evolution detailed in the previous stage.

Using the Tree View the “Evolution 2” architecture version is copied and renamed to a new “Evolution 2—Attempt 1” architecture version. The two additional subsystems (Health and Life) are entered using the Tree View as shown in FIG. 47.

Having populated the tool with the upper levels of the revised implementation architecture the next stage of the process is to extract the lowest level details of the system using the parser component.

The parser is used to gather the lower level details of each subsystems modules (of code) together with associated properties (LoC, % comments etc). These changes and the result of the re-run performance simulation (discussed later) are shown in FIG. 47.

The requirements creep for Evolution 2 within the Requirements State Space (RSS) is shown in FIG. 48. RSS₂ represents a change to RSS₁ with short-tail Health and Life policies added and a resultant additional 20,000 transactions/hour.

Evaluate Evolution 2 (Attempt 1)

Having populated the tool with the entire revised implementation architecture for the evolution the next stage of the process is to simulate the system using the performance simulator component.

The performance simulator is re-run as shown in FIG. 48. It predicts that the Core Networks cluster/node is running at ˜98% which is 1700 MIPS and that there are correctly 100,000 transactions/hour or 27.78 transactions/second.

View Evolution 2—(Attempt 1)

Having populated and simulated with the revised implementation architecture the next stage of the process is to visualise the architecture from various viewpoints to see if the revised architecture meets the evolutions requirements.

The system is close to saturation with only 90% of some of the connections (e.g. Claim and Valid Claim) managing to get through and their Response Times are periodically exceeding their deadlines as shown in FIG. 49.

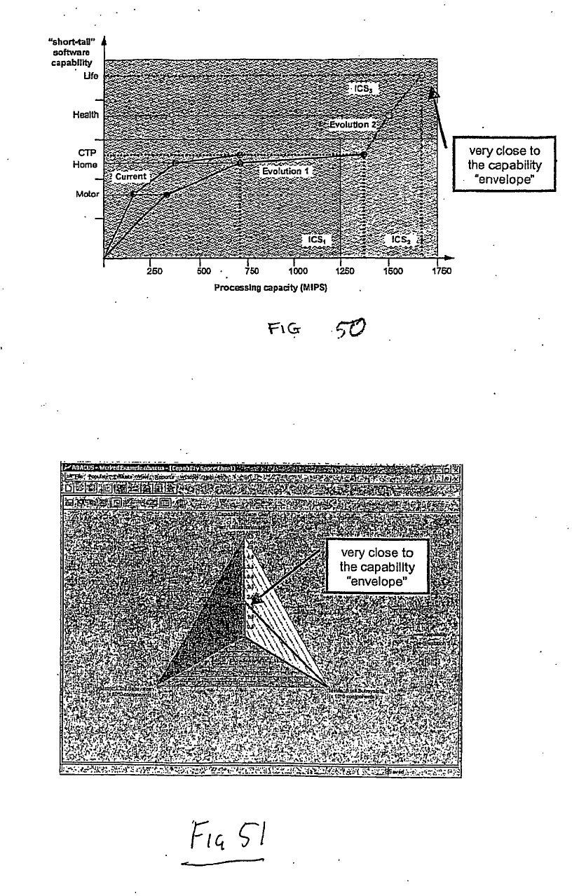

Evolution 2 (Attempt 1) within the Implementation Capability Space (ICS) is shown as a Capability Space Chart in FIG. 50. Scenario 2 requires a scalability change to ICS_{C} where additional short-tail software capability is added.

FIG. 50 supports FIG. 49 and shows that Attempt 1 is not entirely capable of meeting Evolution 2's requirements and the system is too close to saturation to function acceptably. The scalability change required of moving from a single processor system to a multiple processor system is clearly more expensive than the previous adaptability change, as the infrastructure of a cluster processor would have to be installed, with the distribution of processes, the changes to work with a distributed operating system, etc. For the purposes of this example, however, “Evolution 2—Attempt 1” is capable of meeting Evolution 2's requirements and this architectural evolution attempt is renamed to just “Evolution 2”.

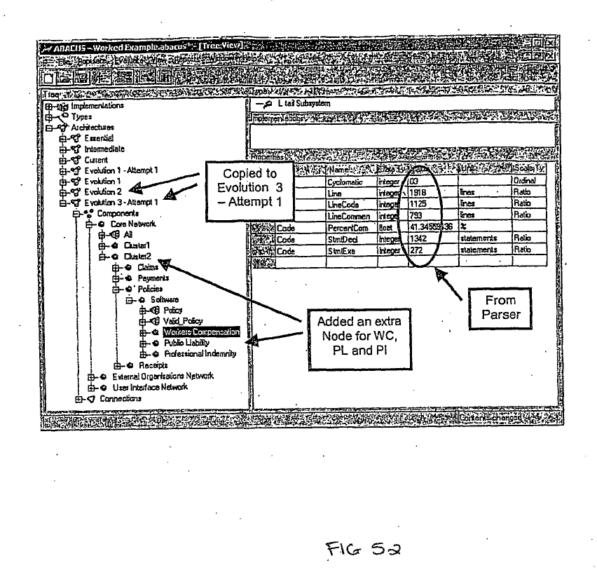

The corresponding Capability Space Radar for FIG. 50 is shown in FIG. 51.

Target System—Evolution 3

Detailing the Evolution

Additional WC, PL and PI long-tail policies, receipts, claims and payments with a resultant additional 30,000 transactions/hour.

Populate Evolution 3—(Attempt 1)

The next stage of the process is to populate the tool with the implementation architecture for the system evolution detailed in the previous stage.

Using the Tree View the “Evolution 2” architecture version is copied and renamed to a new “Evolution 3—Attempt 1” architecture version. The three additional subsystems (WC, PL and PI) are entered using the Tree View. An additional 1750 MIPS cluster is added and the new long-tail software is hosted on it. These changes and the result of the re-run performance simulation (discussed later) are shown in FIG. 52.

Having populated the tool with the upper levels of the revised implementation architecture the next stage of the process is to extract the lowest level details of the system using the parser component.

The parser is used to gather the lower level details of each subsystems modules (of code) together with associated properties (LoC, % comments etc) as shown in FIG. 52.

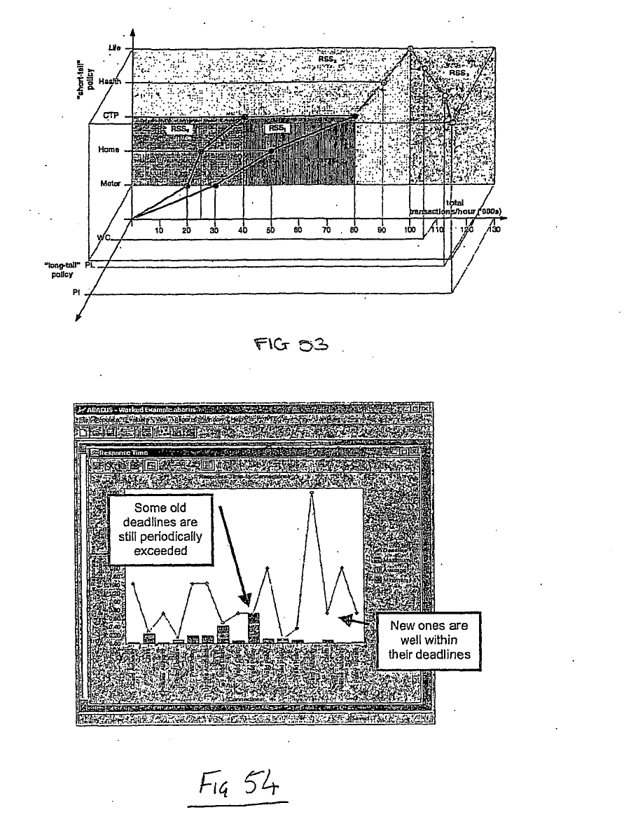

The requirements creep for Evolution 3 within the Requirements State Space (RSS) is shown in FIG. 53. RSS₃ represents a change to RSS₂ with a 3 new long-tail policies (WC, PL and PI) added and a resultant additional 30,000 transactions/hour.

Evaluate Evolution 3 (Attempt 1)

Having populated the tool with the entire revised implementation architecture for the evolution the next stage of the ABACUS process is to simulate the system using the performance simulator component.

The performance simulator is re-run as shown in FIG. 52. It predicts that the new Core Networks cluster/node is running at ˜30% which is 500 MIPS and that there are correctly 30,000 transactions/hour or 8.334 transactions/second.

View Evolution 3 (Attempt 1)

Having populated and simulated with the revised implementation architecture the next stage of the process is to visualise the architecture from various viewpoints to see if the revised architecture meets the evolutions requirements.

It can be seen from the Response time Chart in FIG. 54 that the Response Times for the most of the connections in the revised implementation are well within their deadlines however their has been no change to the Evolution 2 connections periodically exceeding their deadlines.

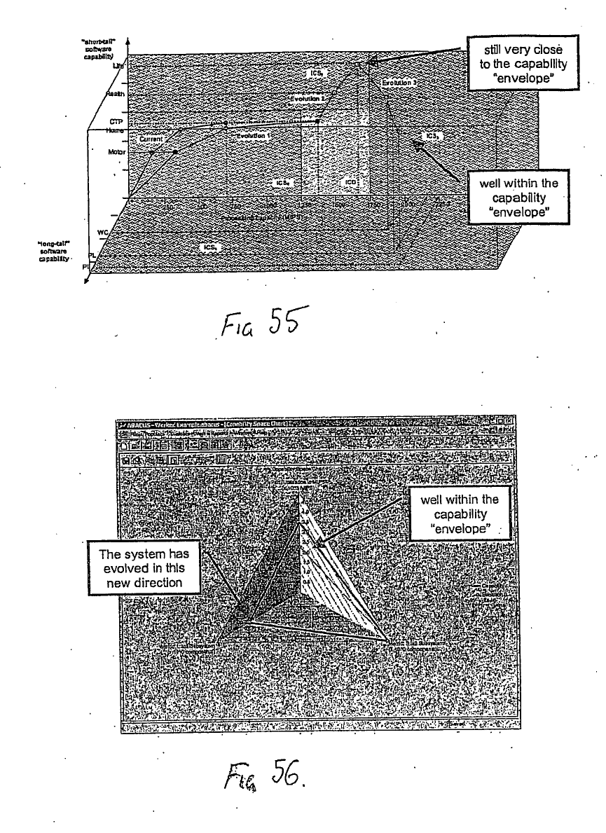

Attempt 1 within the Implementation Capability Space (ICS) is shown as a Capability Space Chart in FIG. 55. Scenario 3 requires a full extensibility change to ICS where the system evolves in a whole new direction by adding long-tail software capability. The scenario also requires a scalability change whereby an additional 1750 MIPS processor is added to handle the additional functionality.

FIG. 55 clearly shows that while Evolution 3—Attempt 1 is capable of handling the change due to Evolution 3 it has done nothing to correct the capability of the system to handle Evolution 2 and the system is still too saturated to function acceptably. As follows, however, for the purposes of this example “Evolution 3—Attempt 1” is capable of meeting Evolution 3's requirements and this architecturally evolution attempt is renamed to just “Evolution 3”.

It can also be seen in FIG. 55 that it is getting difficult to visualise systems that are evolving over more than 2 dimensions. The corresponding capability space radar for FIG. 55 is shown in FIG. 56.

View Current Evolution 1, 2 and 3

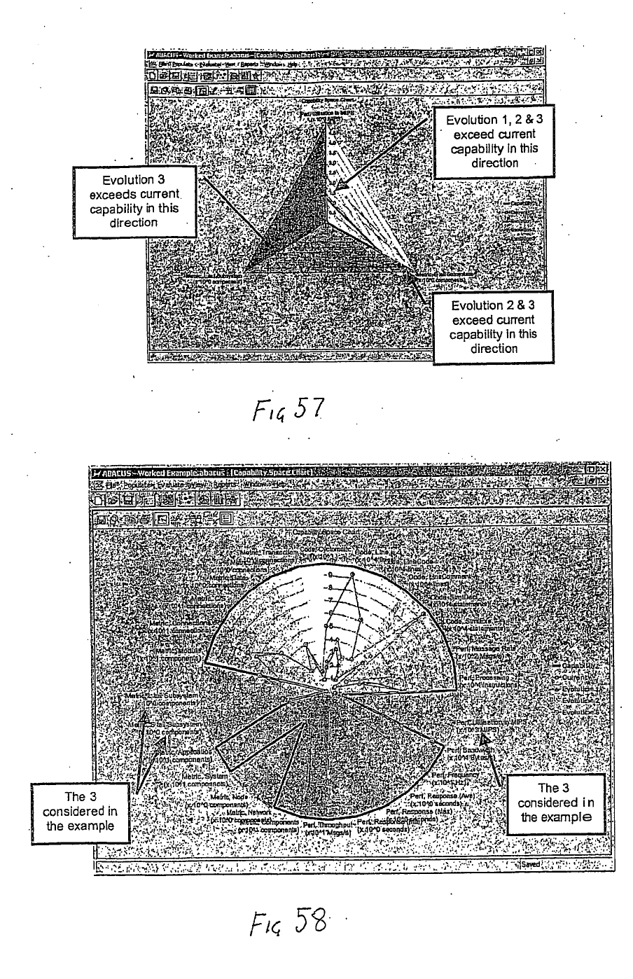

FIG. 37, FIG. 42, FIG. 46, FIG. 51 and FIG. 56 shows the individual Capability Space Radars for each of the current and target evolutions. The tool can combine these to a single radar as shown in FIG. 57 with the capability set at the current system of the single 1250 MIPS plus the hosting three short-tail sub systems (Motor, Home, CTP).

Furthermore, while only three properties (Short-Tail, Long-Tail and Processor Capacity) have been analysed in this example, FIG. 58 illustrates all properties that could be analysed in this embodiment.

The above example demonstrates the tools Architecture-based Analysis Process on a generic insurance system. More specifically it has shown architecture refinement from essential to implementation for an as-built system and then performed change analysis on the system to analyse it's evolution.

In the above embodiment, the complex systems that are modelled and evaluated by the apparatus of the present invention are computing systems. The system and methodology of the present invention could also be applied to other complex systems, not necessarily being computing systems. For example, complex relationships between various organisations could be modelled and evaluated using a system in accordance with the present invention.

In the above embodiment, the system that is assessed the apparatus of the present invention is a complex system. It will be understood that the apparatus of the present invention is not limited in application to complex systems only, but can be applied to any form of system. It is, however, most advantageously applied to a assessment of complex systems.

Modifications and variations as would be apparent to a skilled addressee are deemed to be within the scope of the present invention.

1. An apparatus for analysing systems, the apparatus comprising an architecture storing means for storing architecture information about the architecture of the system, evaluation means for evaluating the architecture in terms of non-functional requirements of the system, utilising the architecture information, and visualisation means for providing a visual representation of the system architecture from the stored architecture information.

2. An apparatus in accordance with claim 1, wherein the visualisation means is arranged to provide a visual representation in the form of a hierarchical three dimensional view.

3. An apparatus in accordance with claim 2, being arranged to represent the stored architecture information as an architectural model, the architectural model including “Components” and “Connections” between the Components, wherein Components are entities within the system and Connections are bonds or relations between Components.

4. An apparatus in accordance with claim 3, wherein Components and Connections may have properties.

5. An apparatus in accordance with claim 4, wherein the Components and Connections include values, for data and/or functional and behavioural parameters.

6. An apparatus in accordance with claim 5, wherein Components and Connections may include Sub-Components and Sub-connections.

7. An apparatus in accordance with claim 6, the model further comprising Ports, Ports being arranged to connect Components and Connections.

8. An apparatus in accordance with claim 7, wherein each Connection Port can only be attached to one Component Port.

9. An apparatus in accordance with claim 8, wherein Connections are first order entities, being recognised as equally important in the model as Components.

10. An apparatus in accordance with claim 9, wherein Components and/or Connections may be designated as a certain Type.

11. An apparatus in accordance with claim 10, wherein Components may be designated as Devices, Devices having processing Capacity.

12. An apparatus in accordance with claim 11, wherein Devices are shared between Components requiring processing capacity.

13. An apparatus in accordance with claim 12, wherein any Component at any level of the hierarchy can be attached via a Connection to any other (or the same) Component and any other (or the same) level of the hierarchy.

14. An apparatus in accordance with claim 13, the model further comprising Implementations including groups of standard Properties collected under a name, standard Implementation and which may be related to multiple Components or Connections.

15. An apparatus in accordance with claim 4, wherein the three dimensional view includes components represented as objects and connections represented as links between the objects, and wherein an object may include, represented within the object space, further components and connections in the system which are of a lower hierarchy within the architecture.

16. An apparatus in accordance with claim 4, wherein different components or connections are distinguished from each other by altering a visual property of each different component or connection.

17. An apparatus in accordance with claim 16, wherein the visual property is the colour of the component or connection.

18. An apparatus in accordance with claim 16, wherein the visual property is the relative size of the component or connection.

19. An apparatus in accordance with claim 16, wherein the visual property is the shape of the component or connection.

20. An apparatus in accordance with claim 15, wherein the visualisation means enables a user to manipulate the three dimensional model in order to access different hierarchy levels.

21. An apparatus in accordance with claim 15, wherein the visualisation means enables the user to manipulate the three dimensional view to see it from different perspectives.

22. An apparatus in accordance with claim 15, wherein the visualisation means is arranged to provide the visual representation in the form of a hierarchical tree view.

23. An apparatus in accordance with claim 15, wherein the visualisation means is arranged to provide a plurality of different visual representations, whereby the architecture of the complex system can be viewed from a plurality of different perspectives.

24. An apparatus in accordance with claim 1, wherein the evaluation means includes a simulation means arranged to utilise the architecture model to simulate operation of the system, whereby the system operation may be evaluated.

25. An apparatus in accordance with claim 1, wherein the architecture storing means is arranged to store a plurality of different levels of abstraction of the architecture, and wherein the apparatus enables a user to view the architecture at any of the plurality of levels.

26. An apparatus in accordance with claim 1, including capability space diagram generating means for generating capability space representations, providing a model of required system capability with respect to systems requirements properties.

27. An apparatus in accordance with claim 26, wherein the capability space representation includes a frame reference axis drawn from the properties that comprise the systems functional schema model.

28. An apparatus in accordance with claim 27, wherein the capability space diagram has more than two dimensions.

29. A method of analysing systems, comprising the steps of obtaining architecture information about the architecture of the system, evaluating the architecture in terms of non-functional requirements of the system, utilising the architecture information, and providing a visual representation of the system based on the obtained architecture information.

30. A method in accordance with claim 29, wherein the step of providing the visualisation includes the step of providing a hierarchical three dimensional view.

31. A method in accordance with claim 30, further including the step of storing the architecture information represented as “components”, and “connections” between the components.

32. A method in accordance with claim 31, wherein the components include information on data, functional and behavioural parameters of the components and the connections include information on data, functional and behavioural parameters of the connections.

33. A method in accordance with claim 31, wherein the components include “ports” connecting to connections.

34. A method in accordance with claim 31, wherein the components include Devices which may be utilised in the system.

35. A method in accordance with claim 31, wherein the architecture information also includes information on constraints of the system.

36. A method in accordance with claim 31, wherein the three dimensional view includes components represented as objects and connections represented as connections between the objects, and wherein an object may include, represented within the object space, further components and connections in the system which are of a lower hierarchy within the architecture.

37. A method in accordance with any one of claim 36, whereby different components or connections are distinguished from each other by altering a visual property of each different component or connection.

38. A method in accordance with claim 37, whereby the visual property is the colour of the component or connection.

39. A method in accordance with claim 37, whereby the visual property is the relative size of the component or connection.

40. A method in accordance with claim 37, whereby the visual property is the shape of the component or connection.

41. A method in accordance with claim 40, further including the step of enabling a user to manipulate the three dimensional model in order to access different hierarchy levels.

42. A method in accordance with claim 41, further including the step of enabling a user to manipulate the three dimensional view to see it from different perspectives.

43. A method in accordance with claim 42, wherein the step of providing the visualisation includes the step of providing a three dimensional tree view.

44. A method in accordance with claim 43, wherein the step of providing a visual representation includes the step of providing a plurality of different visual representations so that the system can be viewed from the plurality of different perspectives.

45. A method in accordance with claim 44, wherein the step of evaluating the architecture includes the step of utilising the architecture information to simulate operation of the system, whereby the system operation may be evaluated.

46. A method in accordance with claim 45, further including the step of enabling re-modelling of the stored architecture information to provide an amended architecture, whereby the amended architecture may be evaluated in terms of non-functional requirements.

47. A method in accordance with claim 46, further including the steps of storing a plurality of different levels of abstraction of the architecture, and enabling a user to view the architecture at any of the plurality of levels.

48. A method in accordance with claim 47, wherein the architecture information is obtained from a representation of a visualisation of an architecture.

49. A method in accordance with claim 48, further including the steps of generating capability space representations, and providing a model of required system capability with respect to systems requirements properties.

50. A method in accordance with claim 49, wherein the capability space representation includes a frame reference axis drawn from the properties that comprise the systems functional schema model.

51. A method in accordance with claim 50, wherein the capability space diagram has more than two dimensions.

52. A method of evaluating a system, comprising the steps of utilising an apparatus in accordance with claim 1 to model the architecture of the system and to evaluate the system in terms of non-functional requirements of the system, utilising the architectural information that has been modelled.

53. A method in accordance with claim 52, including the further step of proposing changes to the architectural model and re-evaluating.

54. A method of developing a system, utilising the apparatus of claim 1, comprising the steps of defining a complex system architecture and modelling the architecture utilising the apparatus of claim 1, and evaluating the system architecture in terms of non-functional requirements it is proposed to meet.

55. A method in accordance with claim 54, comprising the further step of proposing changes to the architectural model and re-evaluating.

56. A method in accordance with claim 55, comprising the further step of engineering the system in accordance with the architecture that has been modelled.

57. A computer program arranged, when loaded onto a computing system, to control the computing system to implement a method in accordance with claim 29.

58. A computer readable medium providing a computer program in accordance with claim 57.
